(19) United States
(12) Patent Application Publication
(10) Pub. No.: US 2020/0260872 A1
(43) Pub. Date: Aug. 20, 2020

(54) Intensive Use Furniture and Method of Manufacture

(71) Applicant: Brian Moon, Sycamore, IL (US)

(72) Inventor: Brian Moon, Sycamore, IL (US)

(73) Assignee: Norix Group, Inc., West Chicago, IL (US)

(21) Appl. No.: 16/792,902

(22) Filed: Feb. 18, 2020

Related U.S. Application Data
(63) Continuation-in-part of application No. 16/792,192, filed on Feb. 15, 2020.
Application No. 16/792,192 is a continuation-in-part of application No. 16/436,914, filed on Jun. 10, 2019.
Application No. 16/436,914 is a continuation-in-part of application No. 16/132,425, filed on Sep. 16, 2018.
Application No. 16/436,914 is a continuation-in-part of application No. 62/683,013, filed on Jun. 10, 2018.
Application No. 16/132,425 is a continuation of application No. 62/561,202, filed on Sep. 20, 2017.

(51) Int. Cl. A47B 96/20; B29C 41/06; B32B 27/06; B32B 3/30; B29C 41/46

(52) U.S. Cl. CPC A47B 96/206; B29C 41/06; B29L 2031/44; B32B 3/30; B29C 41/46; B32B 27/065

(57) ABSTRACT

The intensive use furniture comprises one piece hollow body having a wood grain finish comprising a translucent first layer of plastic such as polyethylene of a first color having a relief portion wherein the translucent first layer comprises ridges and valleys with graduated transitions. The translucent first layer comprises a variable thickness layer on top of a base layer. The base layer having a second complementary color. The hollow body may further comprise a foamed layer of polyethylene on the base layer. Linear support ribs may extend from the foamed layer into the hollow body. The intensive use furniture attached to a building surface by a recessed attachment device having a recessed keyed removal.

### RELATED APPLICATIONS

This application is a continuation-in-part of co-pending US Non-Provisional U.S. application Ser. No. 16/792,192 filed Feb. 15, 2020, which is a continuation-in-part of co-pending US Non-Provisional U.S. application Ser. No. 16/436,914 (Multi-Color) which is a continuation-in-part of U.S. Provisional Patent Application No. 62/683,013, filed Jun. 10, 2018, and a continuation-in-part of then co-pending U.S. patent application Ser. No. 16/132,425 filed Sep. 16, 2018 which is a continuation of then pending U.S. Provisional Patent Application No. 62/561,202, filed Sep. 20, 2017.

### FIELD OF THE INVENTION

The Intensive Use Furniture relates to molded furniture for use in applications of high use in indoor or outdoor environments such as, health care and hospitality facilities.

### BACKGROUND OF THE INVENTION

Molded furniture intensive use furniture is designed for use in demanding environments. Facilities housing individuals for recreation or rehabilitation from health or legal problems require comfortable aesthetically pleasing furniture for safely furnishing living quarters, while being durable. Concealed fasteners for assembly and attachment to floor or wall protects the furniture and the user. The furniture must be assembled and attached to a floor or wall without providing removable parts that may be used as a weapon or tool. Securing the furniture to the floor or wall may further reduce safety concerns of both guests and hosts resulting in a safer environment.

Intensive use furniture may be attached to a floor or wall to prevent movement and use of the furniture to cause damage or injury. In the prior art, furniture may have been bolted to the floor or wall or ballasted with weight to make the furniture too heavy to lift. Assembled multipart furniture may have used threaded fasteners as well to attach components such as an arm rest on a chair. Using threaded fasteners to assemble or attach furniture to a floor or wall may offer an opportunity for a user of the furniture to remove the threaded fastener, such as a bolt, and sharpen an end to use as a weapon. Attempts to hide the fasteners may be overcome by persistent users or prevent moving the furniture without damage. Adhering the furniture to the walls or floor may damage the wall or floor and time may degrade the attachment as the adhesives age. Further such gluing down or hiding fasteners may create problems when the facility manager needs to rearrange the furniture.

Intensive use furniture such as disclosed in Karl U.S. Pat. No. 8,007,059 B2, entitled Intensive Use Furniture is created by rotational molding for durability and ease of cleaning. Such creative manufacturing eliminated fasteners for assembling furniture components. But, the traditional bolt down through a flange on the bottom of side walls may leave the head of the bolt exposed on the top of the flange. The one piece, one color furniture unit is not desired for uses such as hospitality and guest services. Therefore, to provide creatively designed furniture, separately manufactured components and additional aesthetic features such as wood-grain and multi-color effects and recessed fastening enabling fixtures, molded into the furniture, make the product more desirable while protecting the user and others.

Wood-grain effect molded into the furniture provides a pleasing aesthetic making the molded furniture seem more comfortable. By creating a contoured pattern on top of a base shell, with a contrasting color, in a molding process may produce simulated, naturally occurring designs such as wood-grain, stone and other external surface finish designs. These aesthetic designs protect the user and facility. The design is part of the molding process and may not separate while in use. No fasteners such as adhesive is used to attach the surface design. The integral molding of the surface design may reduce manufacturing time and labor to produce.

Multi-color molding using techniques such as zone-control within the mold reduce the labor and cost to produce. By producing an integrally molded multi color product, no assembly fasteners or labor may be needed. Molding one area of the furniture component at a time by selectively heating predefined zones of a mold prior to adding plastic resin, reduces manufacturing time and provides a durable product having integrally molded colors together in a one piece furniture component.

Therefore, it is desirable to provide safe furniture for such facilities with aesthetically pleasing characteristics and design for comfortable use. Therefore there is a need to provide an intensive use furniture product without exposed fasteners and designed for concealed, releasable attachment to a mounting surface such as a wall or floor.

### BRIEF DESCRIPTION OF THE PRESENT INVENTION

The Intensive Use Furniture is a molded furniture design having a surface attach design which may attach the furniture by a concealed attachment device fixing the furniture to a bracket. For purposes of description, the surface attach design shall be discussed as a floor mount. It should be understood, the surface attach design may be adapted to attach to a wall as well. The recessed link may be a keyed ball pin or a tamper resistant fastener. The floor attach may prevent movement of the furniture in an x, y or z axis direction, that is the x axis may be left to right, y axis may be forward and backward and z axis may be up or lifting the furniture. The floor bracket may include a floor mount portion and a furniture interface portion. A mounting tab on the furniture may be adapted to engage the floor bracket. The x-axis mounting tab engaged with the floor bracket may prevent x-axis or z-axis movement. A y-axis link on the furniture shell may be adapted to engage the floor bracket. The y-axis link attached to the floor bracket may be adapted to prevent y-axis or z-axis movement of the furniture. A tab mount portion molded into the furniture may be adapted to receive the x-axis tab.

The tab mount portion may comprise a shaped landing portion, a finger hole and a furniture bolt hole. The x-axis mounting tab may comprise a generally flat bracket portion, a finger link and a tab bolt hole. The bracket portion having a furniture end, a bracket end, a floor surface and a furniture surface. The furniture end and the bracket end aligned in a generally y axis orientation. The furniture surface on the shaped landing portion. The finger link on the bracket portion comprising a first end on the furniture surface and a second end spaced from the furniture surface. The second end extending into the finger hole. A threaded fastener extending through the tab bolt hole into the furniture bolt hole. The threaded fastener having a head bearing on the floor surface whereby the x-axis mounting tab is retained on the furniture.

The y-axis link may be aligned in a generally x-axis orientation. The y-axis link may be on the furniture and attached to the floor bracket. y-axis link The y-axis link may use a means to attach to fix the furniture to the floor bracket. The means to attach may include a threaded fastener, a ball pin or other device on the furniture and removably attached to the floor bracket. The y-axis link may have a tamper resistant interface. The tamper resistant interface may be a tamper resistant head or a keyed actuator or other means.

The furniture skin may comprise a plurality of layers. The skin is formed in a mold having a surface effect mold portion comprising a first predetermined relief pattern etched in the product surface to simulate a desired surface finish. The mold may further comprise a structural effect mold portion comprising a second predetermined pattern etched in the product surface to simulate an assembly of boards or rocks making up the furniture. The furniture skin may comprise one piece penetration resistant shell comprising a surface effect furniture portion and a structural effect furniture portion. The surface effect furniture portion on top of the structural effect furniture portion whereby the outer skin may appear to be formed of boards, the boards having a wood grain pattern thereon. A thin, outer, soft touch layer of a clear or translucent polymer such as poly-ole-fin. A surface effect layer under the soft touch layer may comprise a wood grain effect comprising a thin layer of plastic having a first color. The surface effect layer may comprise a translucent layer. The skin may further comprise a base layer of a plastic such as polyethylene having a second color. The base layer may further comprise inner support ribs extending into the shell. The inner support ribs disposed adjacent to the second predetermined pattern contours to imitate rocks or board shapes. These rock or board shapes The skin may further comprise a foamed layer inside of the polyethylene layer. The foamed layer comprising ribs extending away from the polyethylene layer. The ribs generally aligned with the contours in the polyethylene layer. Integrally molding a surface design saves time and money but the results must look authentic to provide an aesthetic impression. While rotational molding is known in the prior art as charging a closed, heated mold with a polymer and rotating the mold for a predetermined time at a predetermined temperature profile, the method used to make intensive use furniture having a wood-grain finish comprises the steps of:

provide a mold for use in rotational molding, the mold comprising an interior surface, the interior surface comprising an etched portion, the etched portion comprising material removed to form a predetermined design on the interior surface;
provide a liquid polymer;
heat the mold to a first temperature;
provide a wiper for use with the liquid polymer;
wipe the liquid polymer on the etched portion;
dry the etched portion;
close the mold;
heat the mold to a second temperature;
provide a base layer polymer resin;
dispose the base layer polymer resin in the mold;
rotate the mold for a predetermined time;
provide a foaming polymer;
dispose the foaming polymer in the mold;
rotate the mold for a predetermined time; and
cool the intensive use furniture.

Wood Grain design is particularly pleasing for Lounge or Guest chairs, stacking chairs and floor attached chairs. Multi-Color designs appeal to play or informal areas.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a top perspective view of the intensive use bed.

FIG. 2 is a bottom perspective view of the bed of FIG. 1.

FIG. 3 is a top plan view of the bed of FIG. 1.

FIG. 4 is a front elevation view of the bed of FIG. 1.

FIG. 5 is a section view taken at approximately 5-5 of FIG. 4.

FIG. 6 is a section view taken at approximately 6-6 of FIG. 1.

FIG. 7 is an alternate section view taken at approximately 6-6 of FIG. 1.

FIG. 8 is a top perspective view of an alternate embodiment intensive use bed.

FIG. 9 is a top perspective view of the alternate embodiment intensive use bed of FIG. 8 showing the storage drawer.

FIG. 10 is a bottom perspective view of the bed of FIG. 8.

FIG. 11 is a bottom plan view of the bed of FIG. 8.

FIG. 12 is a close up view of the mounting saddle with the bracket attached.

FIG. 13 is a top plan view of a mounting tab.

FIG. 14 is a side elevation view of the mounting tab of FIG. 13.

FIG. 15 is a top perspective view of the mounting tab of FIG. 13.

FIG. 16 is a top plan view of a mounting bracket.

FIG. 17 is a side elevation view of the mounting bracket of FIG. 1.6

FIG. 18 is an end elevation view of the mounting bracket of FIG. 16.

FIG. 19 is a top perspective view of the mounting bracket of FIG. 16.

FIG. 20 is a perspective view of a ball pin.

FIG. 21 is an exploded view of the pin of FIG. 20 with retracting tool.

FIG. 22 is a front elevation of a pin tube.

FIG. 23 is a section view taken at approximately 23-23 of FIG. 22.

FIG. 24 is a mounting end view of the tube of FIG. 22.

FIG. 25 is a top plan view of the mounting tab of FIG. 13 engaged to the mounting bracket of FIG. 18.

FIG. 26 is a top perspective view of the mounting tab of FIG. 13 engaged to the mounting bracket of FIG. 18.

FIG. 27 is a side elevation view view of the mounting tab of FIG. 13 engaged to the mounting bracket of FIG. 18.

FIG. 28 is a section view taken at approximately 28-28 of FIG. 1.

FIG. 29 is a section view taken at approximately 29-29 of FIG. 1.

FIG. 30 is a first step mounting an end wall of the bed of FIG. 1 against a wall.

FIG. 31 is a first step mounting an end wall of the bed of FIG. 1 against a wall.

FIG. 32 is a first step mounting an end wall of the bed of FIG. 1 against a wall.

FIG. 33 is a first step mounting an end wall of the bed of FIG. 1 against a wall.

FIG. 34a is a top plan view of a dog leg tab.

FIG. 34B is a perspective view of the dog leg tab of FIG. 34a.

FIG. 35 is a top plan view of a second alternate intensive use bed.

FIG. 36 is a side elevation view of the bed of FIG. 30.

FIG. 37 is a bottom plan view of the bed of FIG. 30.

FIG. 38 is a top perspective view of the bed of FIG. 30.

FIG. 39 is an end elevation view of the bed of FIG. 30.

FIG. 40 is a top perspective view of a third alternate embodiment intensive use bed.

FIG. 41 is a top plan view of the bed of FIG. 40.

FIG. 42 is a side elevation view of the bed of FIG. 40.

FIG. 43 is a bottom plan view of the bed of FIG. 40.

FIG. 44 is an end elevation view of the bed of FIG. 40.

FIG. 45 is a top perspective of the wood-grain finish view of the bed of FIG. 40.

FIG. 46 is a side elevation view of an intensive use nightstand.

FIG. 47 is a top perspective view of the intensive use nightstand of FIG. 46.

FIG. 48 is a front perspective view of the intensive use nightstand of FIG. 46.

FIG. 49 is a section view taken at approximately 49-49 of FIG. 46.

FIG. 50 is a side elevation view of an intensive use bookshelf.

FIG. 51 is a bottom perspective view of the intensive use bookshelf of FIG. 50

FIG. 52 is a front elevation view of the intensive use bookshelf of FIG. 50.

FIG. 53 is a bottom plan view of the intensive use bookshelf of FIG. 50.

FIG. 54 is a top perspective view of the intensive use bookshelf of FIG. 50.

FIG. 55 is a section view taken at approximately 55-55 of FIG. 54.

FIG. 56 is a bottom perspective view of the intensive use bookshelf of FIG. 50.

FIG. 57 is a top plan view of an intensive use wardrobe.

FIG. 58 is a front elevation view of the wardrobe of FIG. 57.

FIG. 59 is a hinge side elevation view of the wardrobe of FIG. 57.

FIG. 60 is a handle side elevation view of the wardrobe of FIG. 57.

FIG. 61 is a bottom plan view of the wardrobe of FIG. 57.

FIG. 62 is a back elevation view of the wardrobe of FIG. 57.

FIG. 63 is a top perspective view of an intensive use desk.

FIG. 64 is a front plan view of the desk of FIG. 63.

FIG. 65 is a front perspective view of the desk of FIG. 63 with wood-grain finish.

FIG. 66 is a bottom plan view of the desk of FIG. 63.

FIG. 67 is a section view taken at approximately 67-67 of FIG. 66.

FIG. 68 is a section view taken at approximately 68-68 of FIG. 66.

FIG. 69 is a front exploded side elevation view of the desk of FIG. 63.

FIG. 70 is a bottom perspective exploded view of the desk of FIG. 63.

FIG. 71 is a top plan view of an intensive use wall mounted shelf.

FIG. 72 is a front elevation view of the shelf of FIG. 71.

FIG. 73 is a bottom plan view of the shelf of FIG. 71.

FIG. 74 is a side elevation view of the shelf of FIG. 71.

FIG. 75 is a back plan view of the shelf of FIG. 71 showing French cleat receiver.

FIG. 76 is a front top perspective view of the shelf of FIG. 71.

FIG. 77 is a side elevation view of the French cleat adapted to engage shelf of FIG. 75.

FIG. 78 is a front top perspective view of the shelf of FIG. 71 with wood-grain finish.

FIG. 79 is a top plan view of a ligature resistant, skirted arm chair.

FIG. 80 is a front elevation view of the chair of FIG. 79.

FIG. 81 is a bottom plan view of the chair of FIG. 79.

FIG. 82 is a side elevation view of the chair of FIG. 79 the other side being a mirror image.

FIG. 83 is a back elevation view of the chair of FIG. 79.

FIG. 84 is a front top perspective view of the chair of FIG. 79 with wood-grain finish.

FIG. 85 is a front bottom perspective view of the chair of FIG. 79 with wood-grain finish.

FIG. 86 is a top plan view of a ligature resistant, skirted armless chair.

FIG. 87 is a front elevation view of the chair of FIG. 86.

FIG. 88 is a bottom plan view of the chair of FIG. 86.

FIG. 89 is a side elevation view of the chair of FIG. 86 the other side being a mirror image.

FIG. 90 is a back elevation view of the chair of FIG. 86.

FIG. 91 is a front top perspective view of the chair of FIG. 86 with wood-grain finish.

FIG. 92 is a front bottom perspective view of the chair of FIG. 86 with wood-grain finish.

FIG. 93 is a top plan view of a bookshelf.

FIG. 94 is a front elevation view of the bookshelf of FIG. 93.

FIG. 95 is a bottom plan view of the bookshelf of FIG. 93.

FIG. 96 is a side elevation view of the bookshelf of FIG. 93 the other side being a mirror image.

FIG. 97 is a back elevation view of the bookshelf of FIG. 93.

FIG. 98 is a front top perspective view of the bookshelf of FIG. 93.

FIG. 99 is a top plan view of a wall mounted desk.

FIG. 100 is a front elevation view of the wall mounted desk or shelf of FIG. 99.

FIG. 101 is a bottom plan view of the shelf of FIG. 99.

FIG. 102 is a side elevation view of the wall mounted shelf of FIG. 99, the other side being a mirror image.

FIG. 103 is a Back elevation view of the wall mounted shelf of FIG. 99.

FIG. 104 is a front top perspective view of the shelf of FIG. 99.

FIG. 105 is a front top perspective view of the shelf of FIG. 99 with wood-grain finish.

FIG. 106 is a top plan view of a coffee table.

FIG. 107 is a front elevation view of the coffee table of FIG. 106.

FIG. 108 is a bottom plan view of the coffee table of FIG. 106.

FIG. 109 is a side elevation view of the coffee table of FIG. 106 the other side being a mirror image.

FIG. 110 is a top front perspective view of the coffee table of FIG. 106.

FIG. 111 is a front bottom perspective view of the coffee table of FIG. 106.

FIG. 112 is a front top perspective view of a two color stool with wood-grain finish.

FIG. 113 is a front top perspective view of the stool of FIG. 112.

FIG. 114 is a front bottom perspective view of the stool of FIG. 112.

FIG. 115 is a front top perspective view of a wood grain etched mold.

FIG. 116 is a section view taken at approximately—116-116 of FIG. 115.

FIG. 117 is a flow chart of steps to create the wood-grain finish of FIG. 116.

FIG. 118 a front top perspective view of a zone control mold.

FIG. 119 is a flow chart of steps to create the two color finish of FIG. 112.

FIG. 120 is a top plan view of a lamp body.

FIG. 121 is a front elevation view of the lamp body of FIG. 120.

FIG. 122 is a bottom plan view of the lamp body of FIG. 120.

FIG. 123 is a top perspective view of the lamp body of FIG. 120.

FIG. 124 is a top perspective view of the lamp body of FIG. 120 having a table top attached.

FIG. 125 is a top front perspective view of the lamp body of FIG. 120 with wood grain finish.

FIG. 126 is a bottom perspective view of the lamp body of FIG. 120 having a table top attached.

FIG. 127 is a bottom perspective view of the lamp body of FIG. 120.

FIG. 128 is a top plan view of a first alternative lamp body.

FIG. 129 is a front elevation view of the lamp body of FIG. 128.

FIG. 130 is a bottom plan view of the lamp body of FIG. 128.

FIG. 131 is a top perspective view of the lamp body of FIG. 128 having a table top attached.

FIG. 132 is a top front perspective view of the lamp body of FIG. 128

FIG. 133 is a top perspective view of the lamp body of FIG. 128 having a wood-grain finish.

FIG. 134 is a perspective view of the lamp body of FIG. 128 having a table top attached.

FIG. 135 is a bottom perspective view of the lamp body of FIG. 128.

FIG. 136 is a side elevation view of a table.

FIG. 137 is a bottom plan view of the table of FIG. 136.

FIG. 138 is a top perspective view of the table of FIG. 136.

FIG. 139 is a top plan view of the table of FIG. 136.

FIG. 140 is a top perspective view of the table of FIG. 136 having wood grain finish.

FIG. 141 is a bottom perspective view of the table of FIG. 136.

FIG. 142 is a top plan view of a bench.

FIG. 143 is a front elevation view of the bench of FIG. 142.

FIG. 144 is a bottom plan view of the bench of FIG. 142.

FIG. 145 is a top perspective view of the bench of FIG. 142.

FIG. 146 is a side elevation view of the bench of FIG. 142.

FIG. 147 is a top perspective view of the bench of FIG. 142 with wood-grain finish.

FIG. 148 is a top plan view of a bench with back.

FIG. 149 is a front elevation view of the bench of FIG. 148.

FIG. 150 is a bottom plan view of the bench of FIG. 148.

FIG. 151 is a side elevation view of the bench of FIG. 148.

FIG. 152 a back elevation view of the bench of FIG. 148.

FIG. 153 is a top perspective view of the bench of FIG. 148.

FIG. 154 is a top perspective view of the bench of FIG. 148 having a wood-grain finish.

FIG. 155 is a top plan view of a table.

FIG. 156 is a side elevation view of the table of FIG. 155.

FIG. 157 is a bottom plan view of the table of FIG. 155.

FIG. 158 is a perspective view of the table of FIG. 155.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting. It should be appreciated that the invention can be used for any suitable.

Referring to FIG. 1, an intensive use furniture piece 10 such as bed 12 may have a top 14 sidewalls 16, end walls 18 and a bottom 20 mounted on a floor. The top 14 may comprise a mattress pocket 22 and a ridge 24 formed in the top surface.

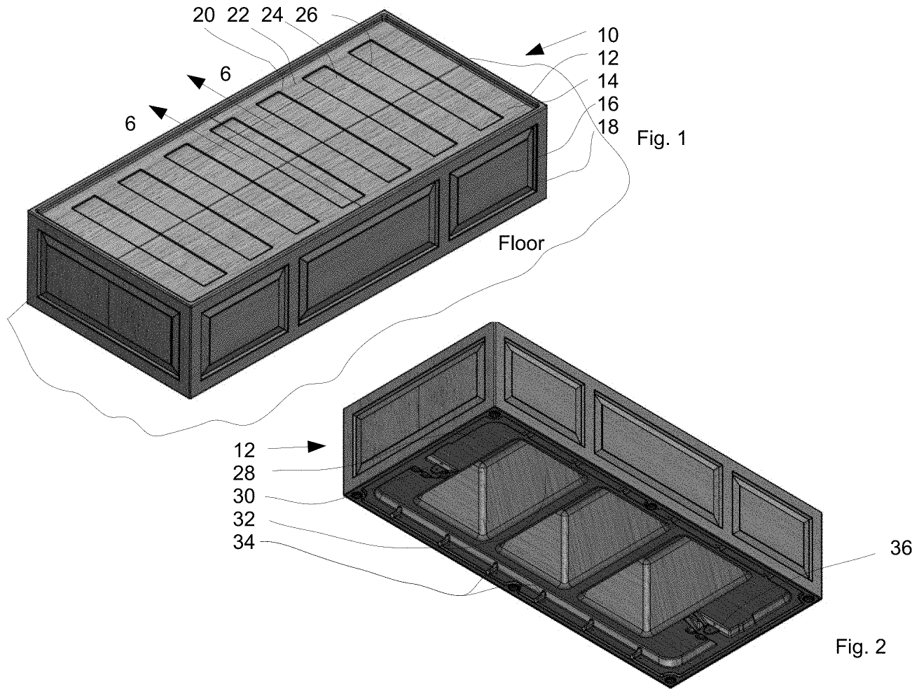

Referring to FIG. 2, the bed 12 may further comprise a bottom 20 having a mounting saddle 30 and a plurality of support openings 32. Support openings 32 extend inward to the hollow interior to a location adjacent the mattress surface. Notches 34 in the outer perimeter of the bottom 20 are adapted to receive a.

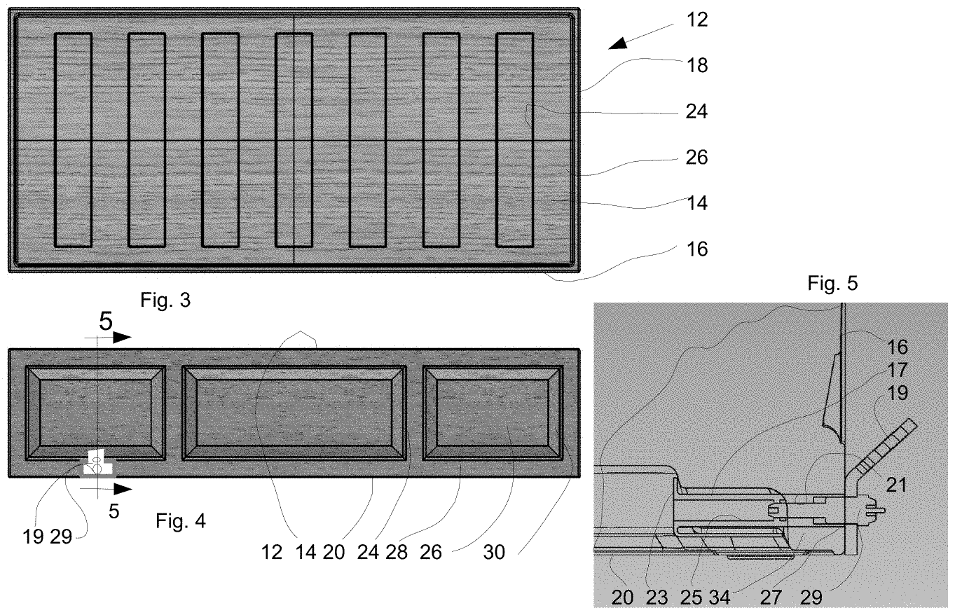

Referring to FIGS. 3-4, the bed 12 may comprise support contours 24 formed in a repeating pattern on the top 14 and a raised panel portion 25 on side walls 16 and end walls 18. The wood-grain layer 26 longitudinal lines horizontally 28 between and the walls 18 or alternatively, may extend vertically 30 between the top 14 in the bottom 20. Restraint ring 19 may be mounted on side wall 16 in notch 34.

Referring to FIG. 5, restraint ring adapter 17 may be disposed in notch 34 by drilling hole 21 in outer shell 36. Adapter flange 23 bears against bottom 20. Adapter tube 25 may comprise first end on adapter flange 23 and second end 27 in hole 21 adjacent shell outside 38. Adapter flange 23 may be anchored with screw to sidewall 16. Restraint ring 19 may be quickly released by ball pin 29 engaged to restraint ring adapter 17. Ball pin 29 bears against restraint ring 19 locking restraint ring 19 between ball pin 29 and shell outside 38.

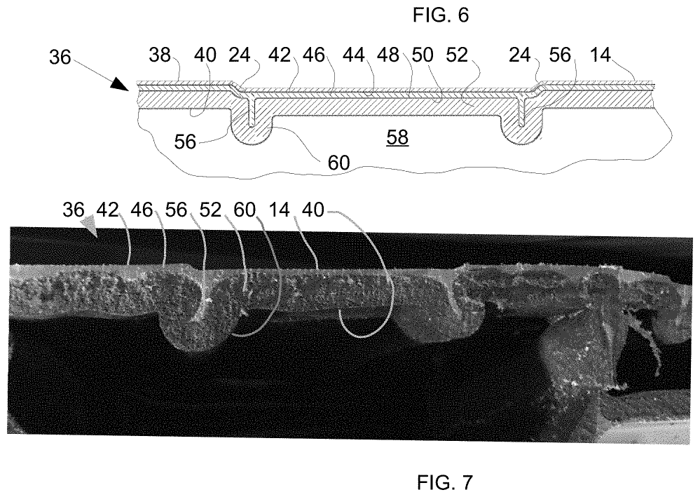

Referring to FIGS. 6-7, a cutaway taken at approximately 6-6 of FIG. 1 shows the cross section of the outer shell 36 having a shell outside 38 and a shell inside 40. A first translucent layer 42 comprising a polyethylene compound such as is available at Mold In Graphics of Clarkdale, Ariz., such as Color In Systems having a first color is disposed on the shell outside 38. The first translucent layer 42 may comprise an inner surface 44 bonded to a second base layer 46 comprising a polyethylene or similar material. The second base layer 46 may comprise an outside surface 48 bonded to the first translucent layer 42. The second base layer 46 may further comprise an inside surface 50 bonded to a third foamed layer 52 comprising a foamed plastic material such as polyethylene.

Continuing to refer to FIGS. 6-7, the foamed polyethylene layer 52 may be molded onto second base layer 46. The foamed polyethylene layer 52 may further comprise shell inside 40 surrounding the hollow interior 58. The contour 24 in the outer surface 38 extends through first translucent layer 42 and the second base layer 46. Adjacent to the contour 24, the second base layer 46 may comprise an attach rib 56 extending into the open interior 58 and increasing the attachment area between second base layer 46 and foamed layer 52. The attach rib 56 is surrounded by the foamed layer 52 forming support rib 60 on the shell inside 40.

Referring to FIGS. 8-9, an alternative embodiment of the intensive use in bed 60 comprising retaining ridge 62 surrounding mattress support surface. Handle opening 66 may be used to access storage compartment 68 which may comprise a drawer 70 attached to the bed 60.

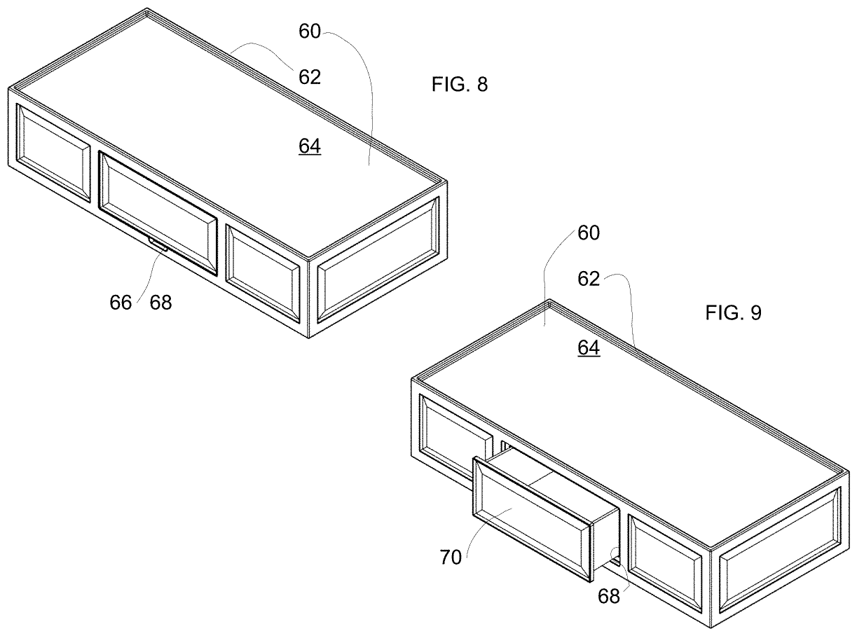

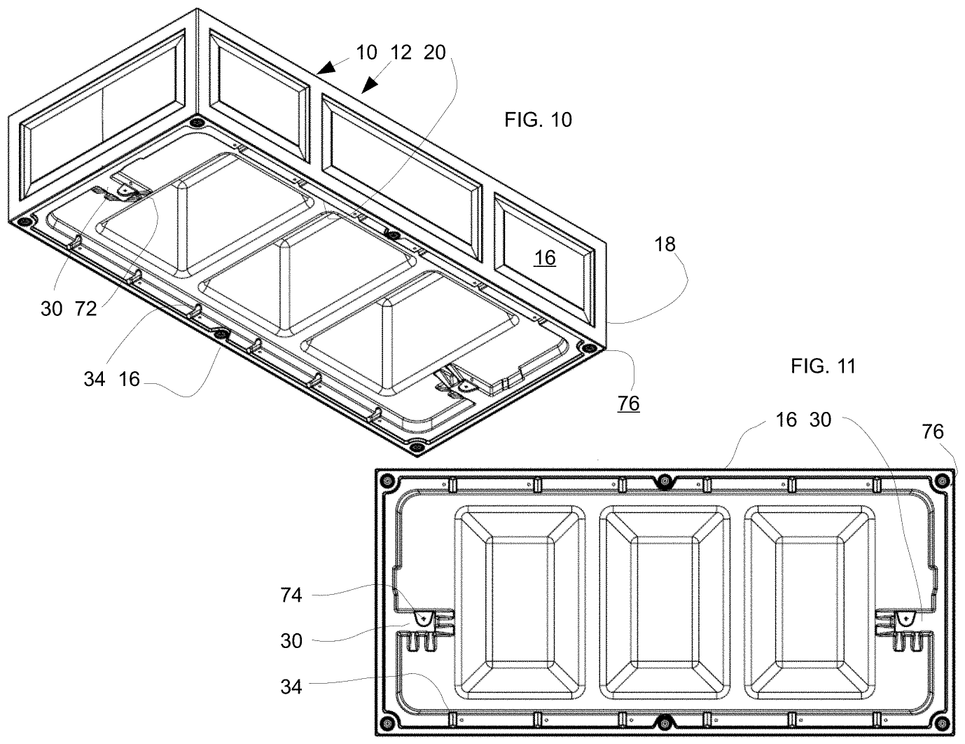

Referring to FIGS. 10-11, furniture piece 10 may further comprise a mounting saddle 30 formed in the bottom 20. Mounting saddle 30 further comprises a tab bolthole 72 and eight have a screw hole 74 opening to the bottom 20. The saddle 30 may be disposed adjacent one or both and end walls 18 and spaced generally between sidewalls 16. Restraint mount 34 is formed as a channel generally perpendicular to the respective sidewall 16.

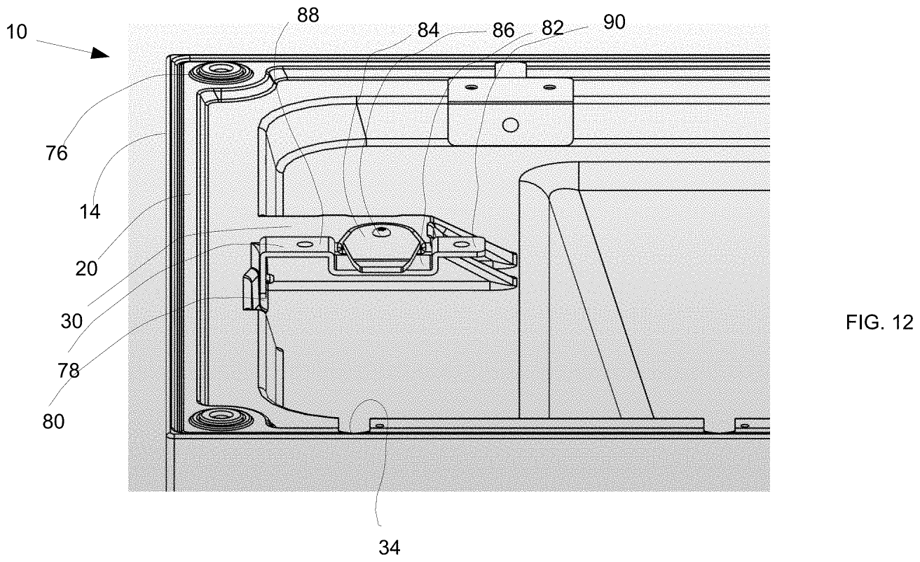

Referring to FIG. 12, the mounting saddle 30 is disposed on bottom 20 and may be spaced from the end walls 18 and side walls 16. Tamper resistant glides 76 may be disposed in the corners of furniture piece 10. The furniture piece 10 may be attached to a floor or a wall in a similar fashion. A building bracket 78 may comprise a pin flange 80 and a tab flange 82. Tab 84 may be attached to furniture 10 by screw 86 extending through tab 84 and into screw hole 74 (FIG. 11). Building bracket 78 may further comprise a first building flange 88 and a second building flange 90.

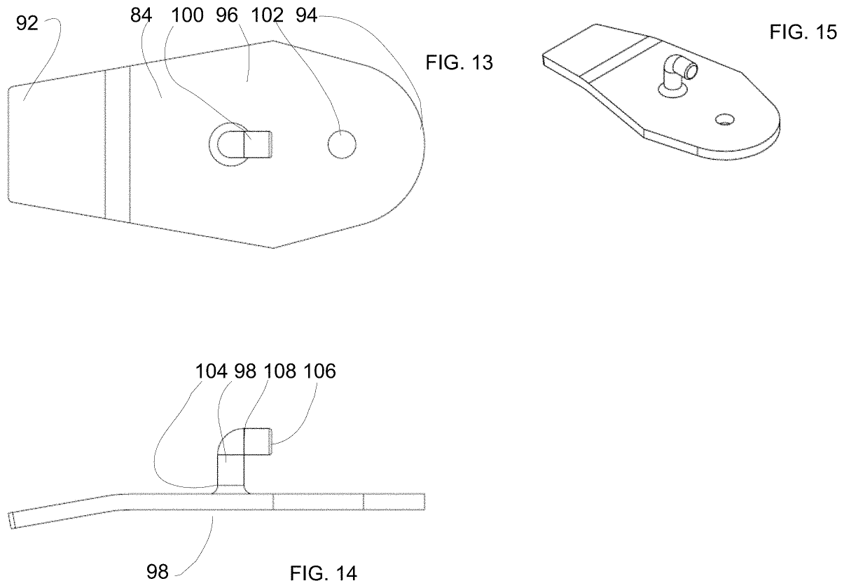

Referring to FIGS. 13-15, the tab 84 may further comprise a bracket end 92, a furniture end 94, a furniture side 96, a building surface side 98, a bolthole 102, and support finger 100. The support finger 100 is disposed to provide support for tab generally perpendicular to bottom 20. Support finger may be disposed between bolt hole 102 and bracket end 92. Support finger 100 may comprise a first end 104 and a second end 106. First end 104 is adapted to attach to top side 96. Second end 106 is spaced from tab 84. Second end 106 is adapted to engage furniture 10. In the preferred embodiment, support finger 100 may further comprise a bend 108 between first end 104 and second end 106.

Continuing to refer to FIGS. 13-15, the furniture end on the mounting surface, the bracket end on the building surface bracket

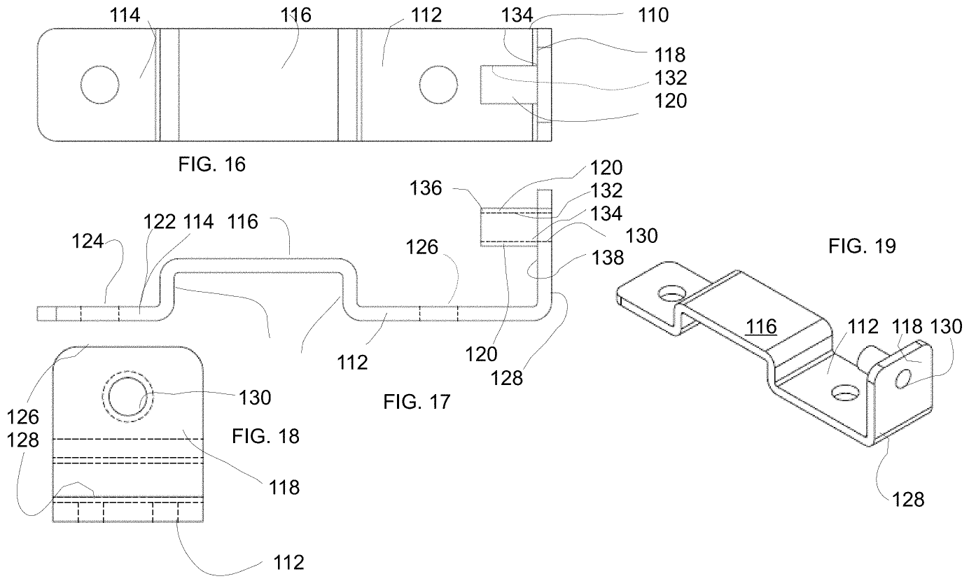

Referring to FIGS. 16-19, the building bracket 110 for use with a floor or a wall. The building surface bracket 110 comprising a first and second building flange 112, 114, a tab flange 116, and a pin flange 118. The first building flange 112 adapted to attach to building surface such as floor or wall by bolt holes 124, 126 formed in the first and second building flange 112, 114. A locking collar 120 may be attached to pin flange 118. Pin flange 118 may comprise a first end 126, a second end 128 and a pin hole 130. First pin flange end 126 on the first building flange 112. second pin flange end 128 spaced from first building flange 112. Pin flange 118 disposed generally perpendicular to first building flange 112. Locking collar 120 may be disposed on pin flange 118 between first pin flange end 126 and second pin flange end 128. Locking collar 120 may be a hollow tube welded or other wise connected to pin flange 120. Locking collar 120 may be disposed generally concentric with the pin hole 130. Locking collar may comprise a pin chamber 132, a flange end 134 and a pin end 136. Flange end 134 attached on the locking side 138. Pin end 136 spaced from the locking side 138. Pin chamber 132 generally concentric with the pin hole 130. Tab flange 116 may be disposed between first and second building surface flanges 112, 114.

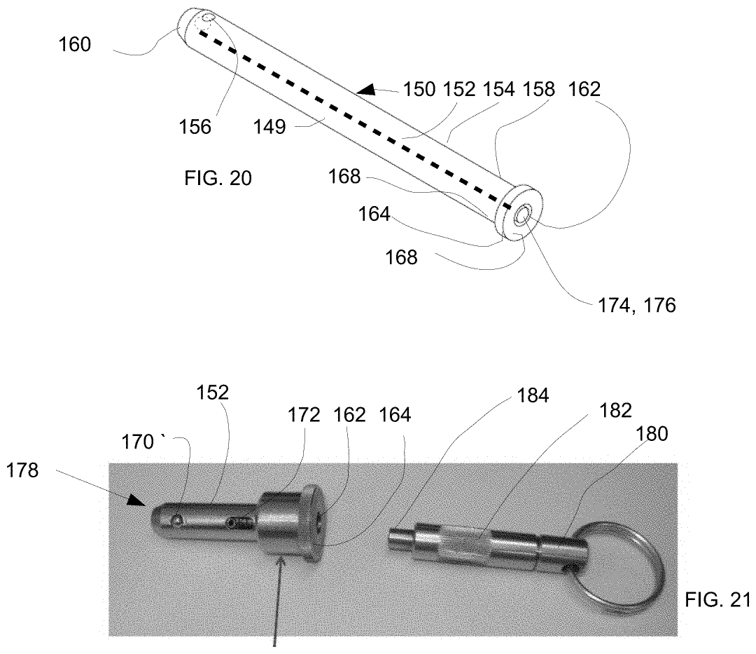

Referring to FIGS. 20, 21, an elongate connector 149 may comprise a ball pin 150 comprising a shaft 152, an pin outside 154, a ball hole 156, a proximal end 158 and a distal end 160. Shaft 152 may comprise a hollow conduit 162 opening to the proximal end 158 and extending in the shaft 152 to the ball hole 156. Ball hole 156 extends from pin outside 154 to hollow conduit 162. Proximal end 154 may comprise a flange 164 comprising a mounting surface side 166 and a locking side 168. Retractable ball 170 may be disposed in hollow conduit 160 adjacent to ball hole 156. Ball retractor 174 may be slidingly disposed in hollow conduit 162. Ball retractor 174 may comprise retractor engagement 176 adjacent to proximal end. Ball retractor 174 bears against retractable ball 170. Spring 172 in hollow conduit 162 bears against shaft 152 and ball retractor 174. Spring 172 is adapted to urge ball retractor 174 to bear against retractable ball 170 to urge retractable ball 170 to nest in ball hole 156 wherein ball extending portion 176 of retractable ball 170 extends from pin outside 154. Ball hole 156 may be formed adjacent the distal end 160. Retractable ball 170 in the hollow conduit 160. Retractable ball 170 adjacent to the ball hole 156 and extending from the ball hole 156 by the extending portion 176 in the locked position 178 having the spring bearing against the shaft and the ball retractor 174, the retractable ball 170 in the ball hole 156 having the extended portion 176 extending from pin outside 154.

Continuing to refer to FIG. 21, a retractor tool 180 may comprise a shaft 182, an engagement end 184 and a tool shoulder 186. Engagement end 184 may comprise a threaded shaft adapted to thread into ball retractor 174. Engagement end engages ball retractor 174 by threadable engagement whereby tool shoulder 186 bears against mounting surface side 166 threadable engagement urging ball retractor 174 to traverse toward proximal end 158 urging retractable ball 170 to move out of ball hole 156 and into hollow conduit 162 to a non locking position 188 wherein retractable ball 170 is not nested in ball hole 156.

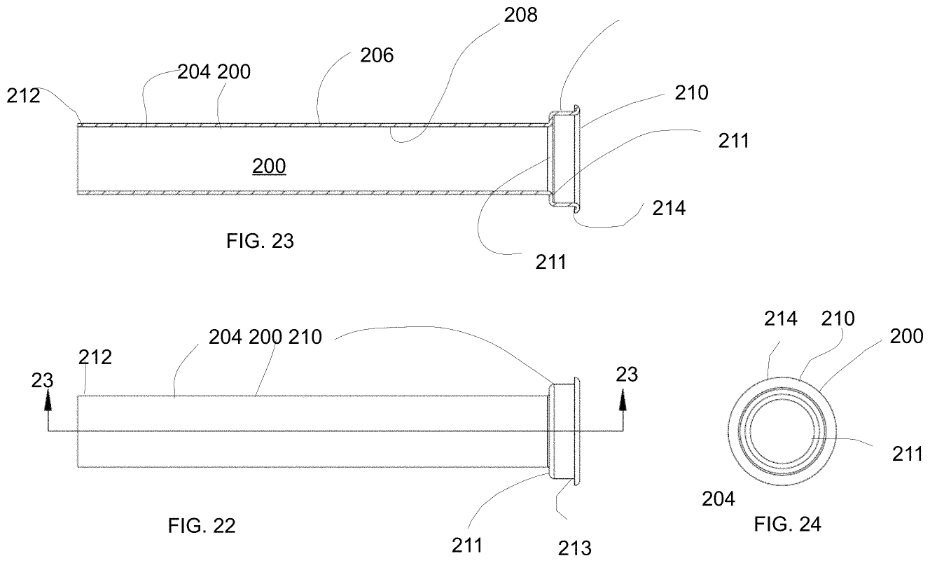

Referring to FIGS. 22-24, a pin tube 200 adapted to receive elongate connector 149 (FIG. 21) may comprise comprises a hollow tube 204, a tube outside 206, a tube inside 208, a shell end 210, a retractor seat 211 and a pin flange end 212. Tube outside 206 extending from the shell end 210 to the pin flange end 212. Shell end 210 comprising a shell flange 214. Retractor seat 211 may be recessed into pin tube 200 from shell end 210. Shell end 201 may further comprise outside flange 214 having shell side 213.

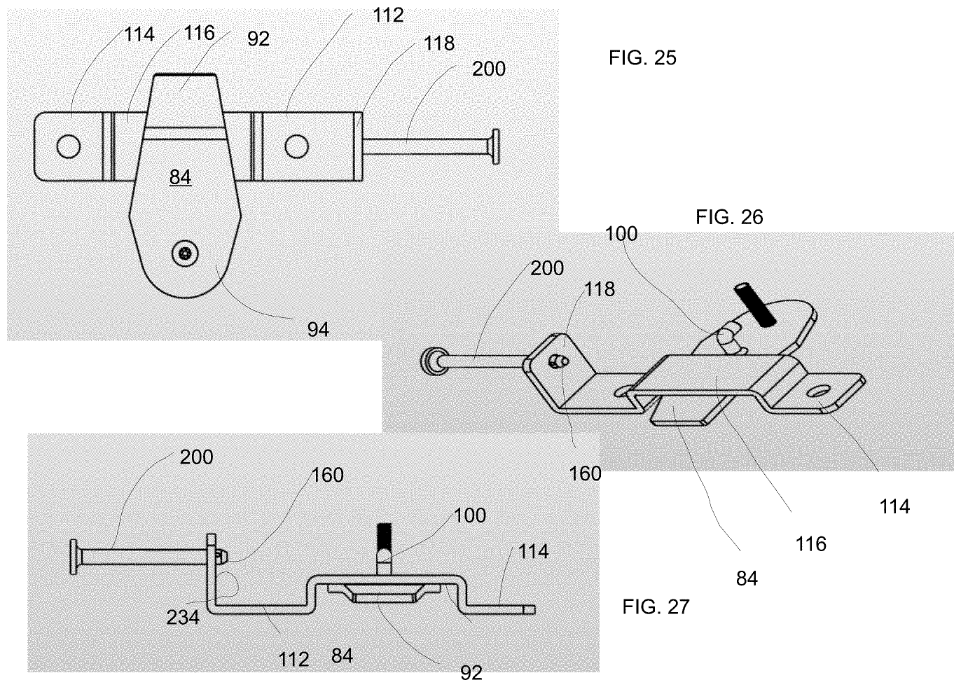

Referring to FIGS. 25-27 the building bracket 110 is engaged to tab 84 at bracket end 92. Pin tube 200 bears against pin flange 118 on building bracket 110. Proximal end 160 extends through pin flange 118 having extended portion 176 of retractable ball 170 extending from pin hole and engaging pin flange 118 on locking side 230. Pin tube 200 extends from mounting surface side 232 of pin tube 200.

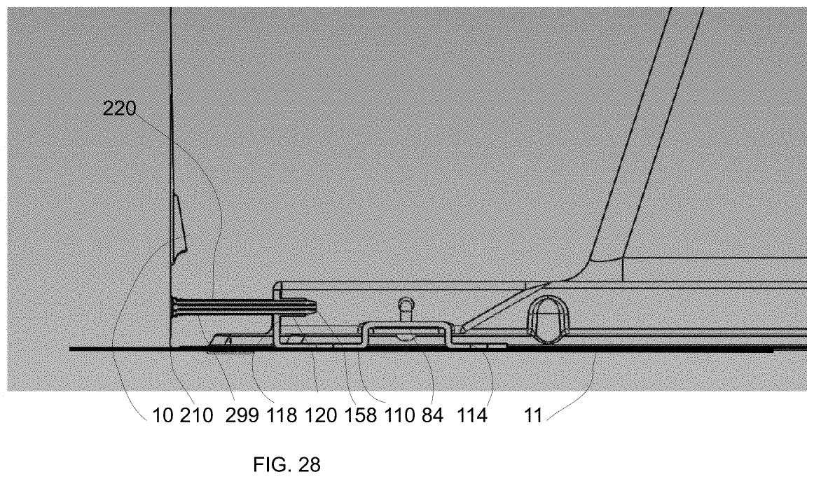

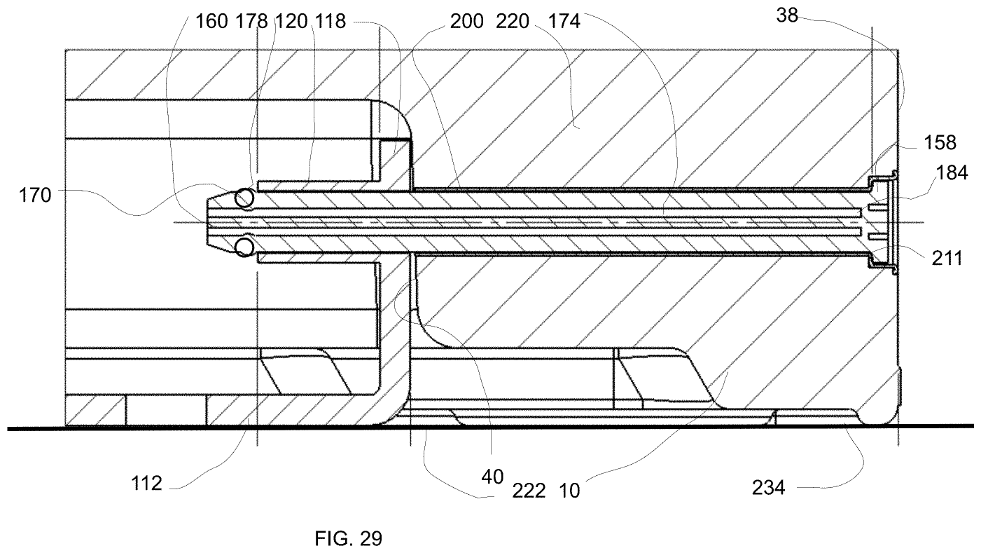

Referring to FIGS. 28 and 29, the furniture 10 has mounting hole 220 drilled from shell outside 38 to shell inside 40 proximate mounting saddle 30. Pin tube 200 is disposed in the mounting hole 218 having the proximal end engaged to the shell and the distal end extending through the pin tube 200 through the pin hole in the pin flange to the mounting side of the pin flange 118. the locking collar 120 is disposed on the mounting side of the pin flange. The extending portion 176 extends from ball hole and engages locking tube 120. Proximal end 158 of the elongate connector bearing on the connector flange 211. Ball retractor 174 bearing on retractable ball 170 and extending to proximal end of pin tube 200. Engagement end 184 is disposed adjacent to proximal end of pin tube 200.

Referring to FIGS. 30-33, dog leg tab 220 may comprise furniture end 222, and bracket hook 224. Dog leg tab 220 attaches to furniture 10 as tab 84 discussed with respect to FIG. 25. Tab seat 226 formed in mounting saddle 20 is adapted to receive furniture end 222 with screw 226 extending through dog leg tab 220 into furniture 10. dog leg tab 220 may comprise flange extension 228 and bracket hook 230 oriented toward end wall 16. in coordination with first building bracket 110 and second building bracket 232, dog leg tab 220 may be used to attach furniture 10 shown as bed 12 to floor 234 between first wall 236 and second wall 238 forming corner 240 by the steps:

1. attach first and second building brackets to floor 234.

2. attach tab 84 to first mounting saddle 20 and dog leg tab 220 to second mounting saddle 236.

3. drill mounting hole 218 from shell outside 38 to mounting saddle 20.

4. push end of bed with dog leg hook to engage second building bracket 232 with bracket hook 230.

5. push bed to an orientation having end wall 16 parallel to first wall 236 disposing tab flange between bracket hook 230 and furniture end 222.

6. Insert pin tube 200 in mounting hole 220.

7. Insert ball pin in pin tube having shaft in pin hole on pin flange 118.

8. Engage ball retractor with retractor tool to urge retractable ball into hollow conduit.

9. Insert ball pin into locking collar 120 having ball hole adjacent locking end 136.

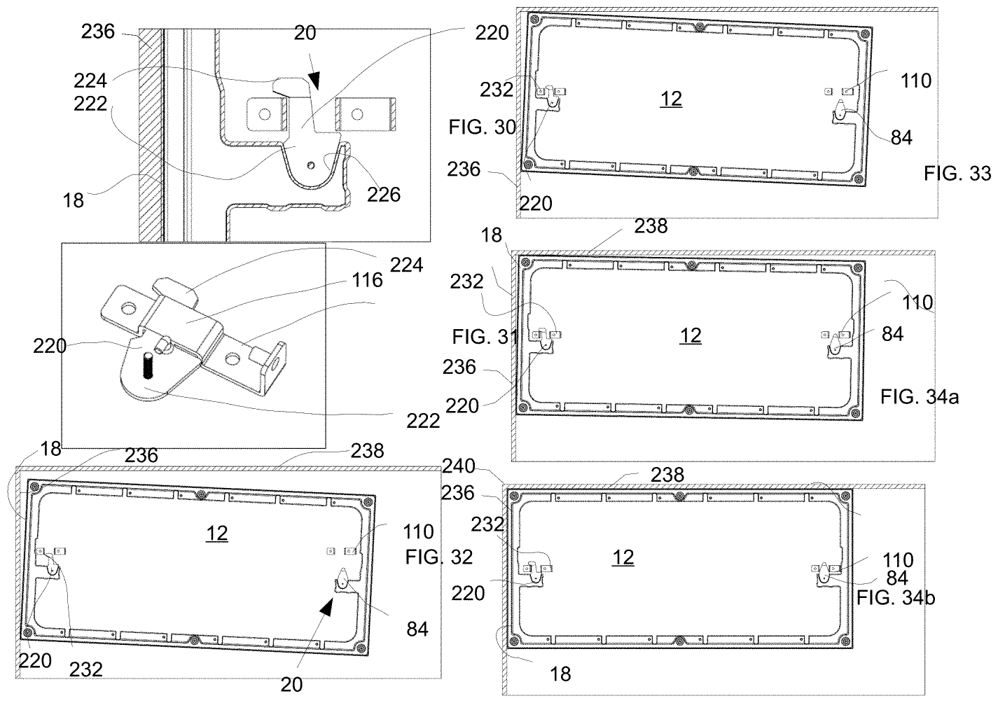

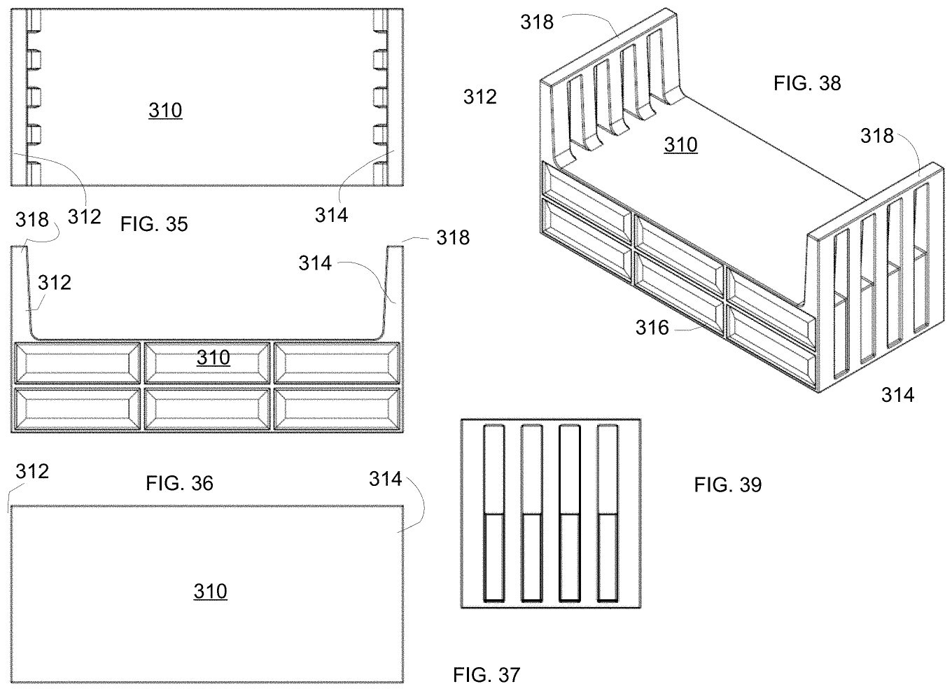

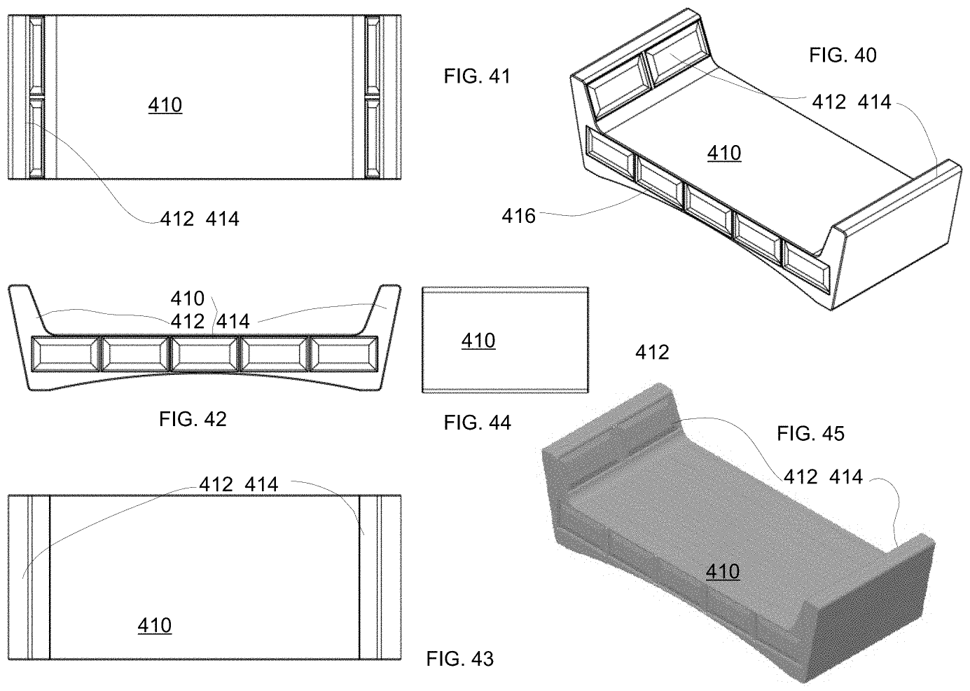

Referring to FIGS. 35-39 an alternative intensive use bed 310 may comprise foot risers 312, head risers 314, raised panel design 316 concealing storage 318. foot risers 312 and head risers 314 may further comprise linking surface 318 to allow a second bed 310 to be stacked in a bunk bed configuration.

Referring to FIGS. 41-45 an alternative intensive use bed 410 may comprise foot risers 412, head risers 414, raised panel design 416 concealing storage 418.

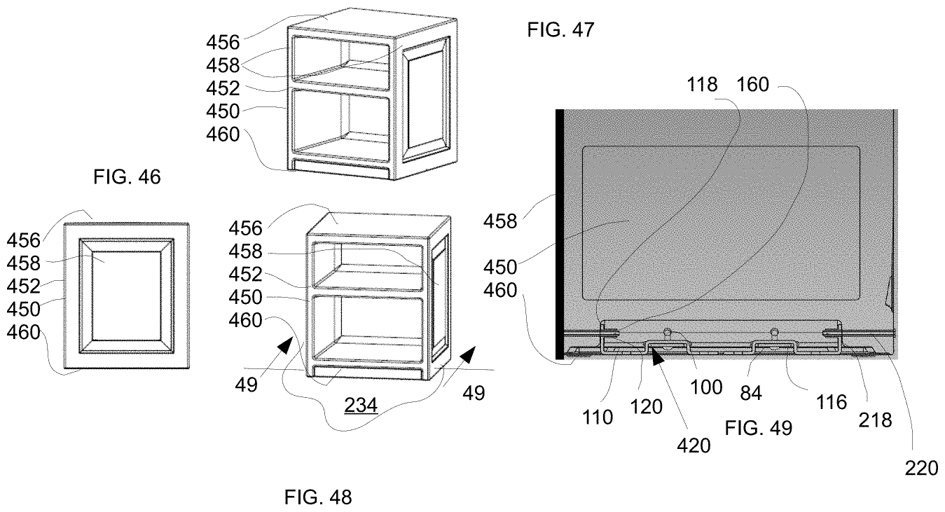

Referring to FIGS. 46-48 a night stand 450 may comprise a front 452, a back 454, a top 456, a pair of sidewalls 458 and a bottom 460. A mounting saddle 420 may be formed in bottom 460. attachment to a floor. A concealed floor attachment device may comprise a building bracket 110 having a pin flange 118 and a tab flange 116 attached to floor 234. Mounting hole 220 formed in shell extends into mounting saddle 420.

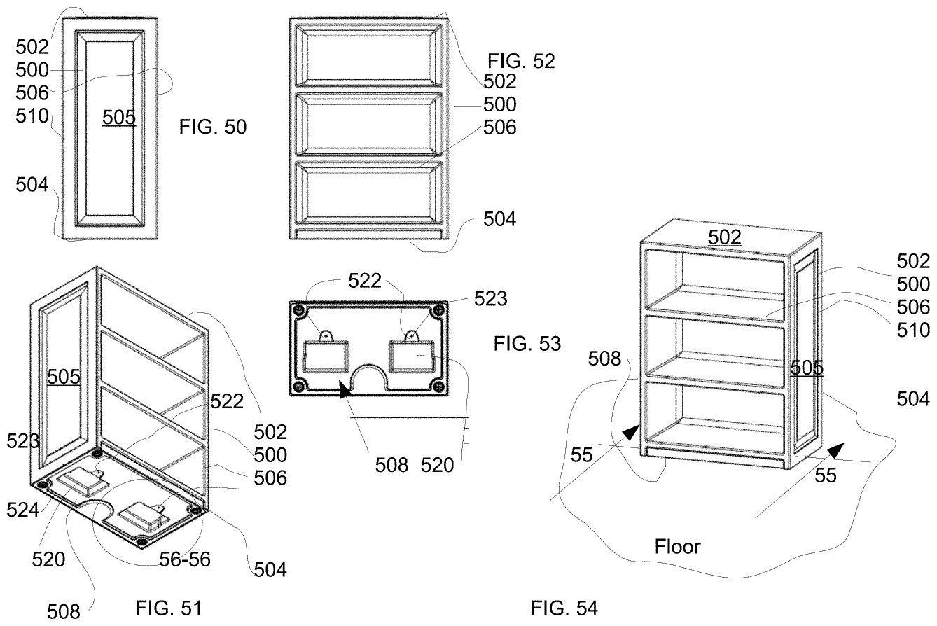

Referring to FIGS. 50-54, a book shelf 500 may comprise a top 502, a bottom 504, a pair of side walls 505 and a front 506. A mounting surface 508 chosen from the top 502, one side 505, bottom 504, or back 510 may further comprise a mounting saddle 520 formed on the shell outside 512. The mounting saddle 520 may comprise a tab seat 522 having a screw hole 523 extending into the shell 524. For floor 234 attachment, the mounting saddle 520 may be disposed on the bottom 504.

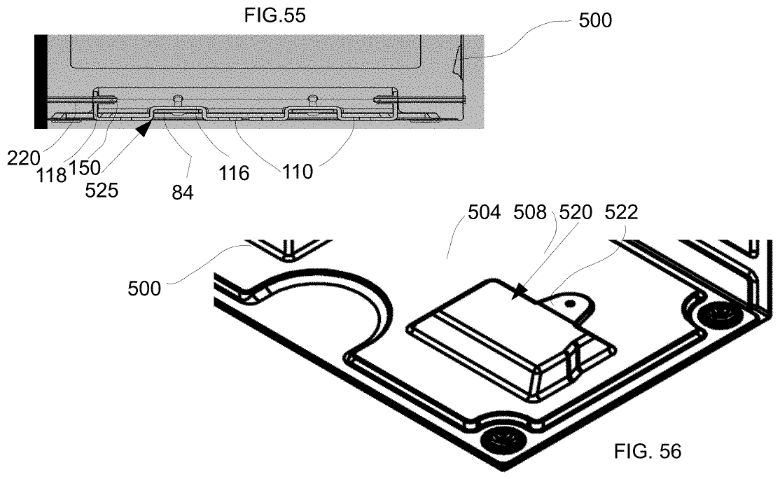

Referring to FIGS. 55-56, the book shelf 500 may comprise a mounting surface 508 chosen as the bottom 504 comprising a mounting saddle 520 comprising a tab seat 522. A concealed floor attachment device 525 may comprise a building bracket 110 having a pin flange 118 and a tab flange 116 attached to floor 234. Mounting hole 220 formed in shell extends into mounting saddle 420.

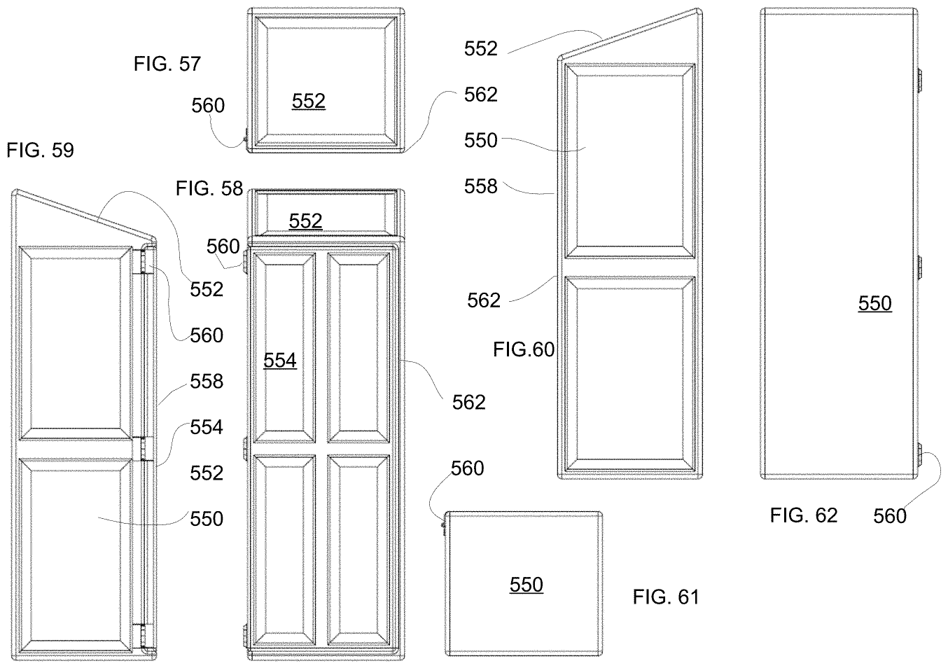

Referring to FIGS. 57-62, intensive use furniture 10 may be configured as a wardrobe 550. Wardrobe 550 may comprise a ligature resistant sloping top 552, a ligature resistant door 554 having a closed hinge connection 556 to wardrobe front 558 and a releasable hinge 560 configured to break away from wardrobe 550 if a weight of more than a predetermined weight is applied to the handle side 562 of door 554.

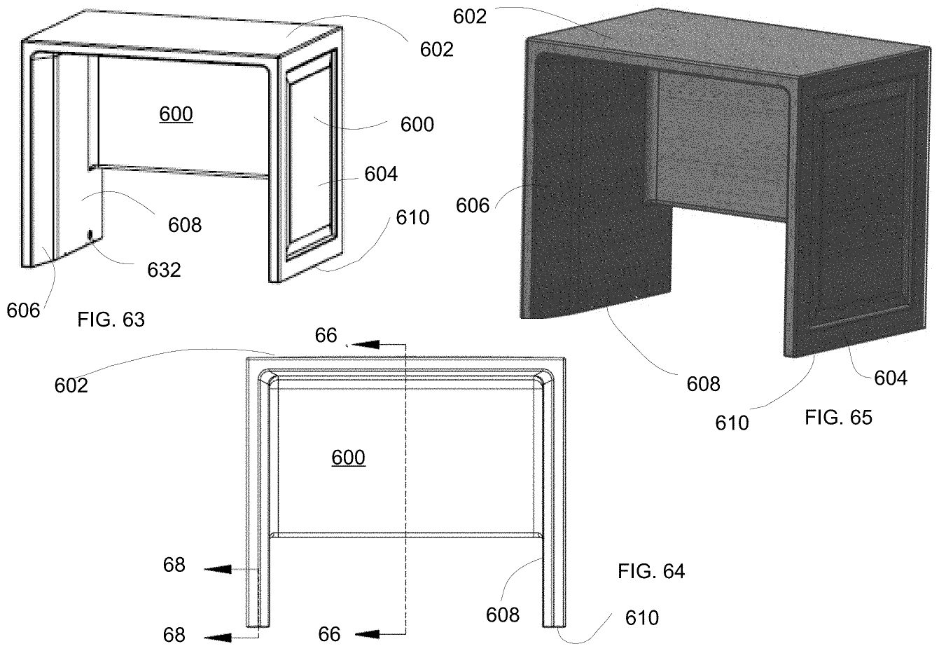

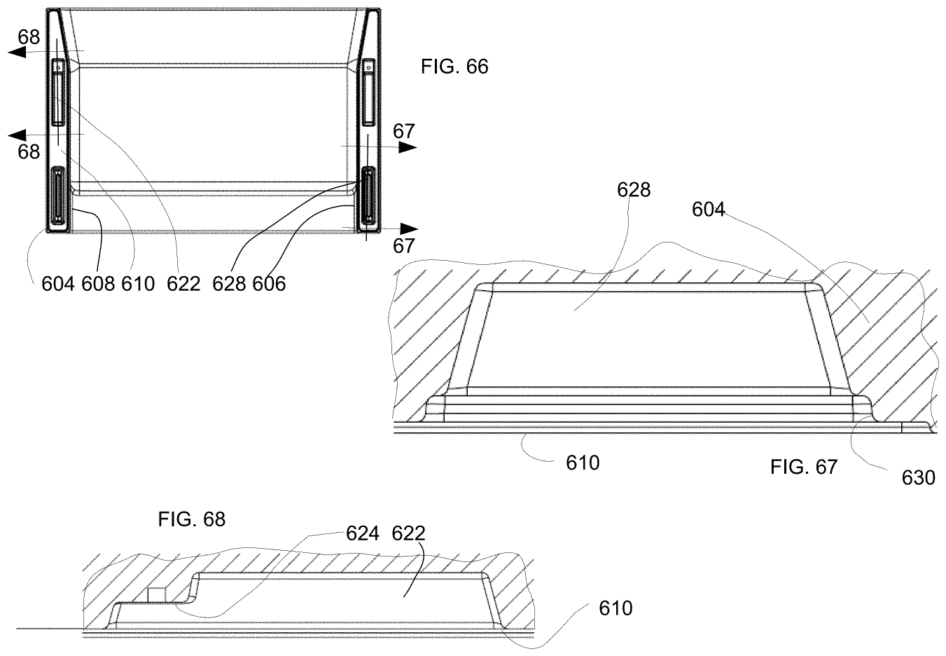

Referring to FIGS. 63-68, intensive use furniture 10 may be configured as a desk 600. The desk comprising a writing surface 602 a first leg 604, a second leg 606, and a mounting saddle 620. Each leg 604, 606 comprises an inside surface 608, a bottom 610 and an outside surface. The legs 604, 606 attached to the writing surface 602. A mounting saddle 620 formed in the bottom 610. The mounting saddle 620 comprising a flange opening 622 and a bolt tab pocket 628. The flange opening 622 comprising a flange shelf 624 disposed generally horizontal and adapted to engage a sliding flange 626. The bolt tab pocket 628 comprising an opening 630 into the bottom 610 and a bolt hole 632. The bolt hole 632 extending from the inside surface 608 to the bolt tab pocket 628.

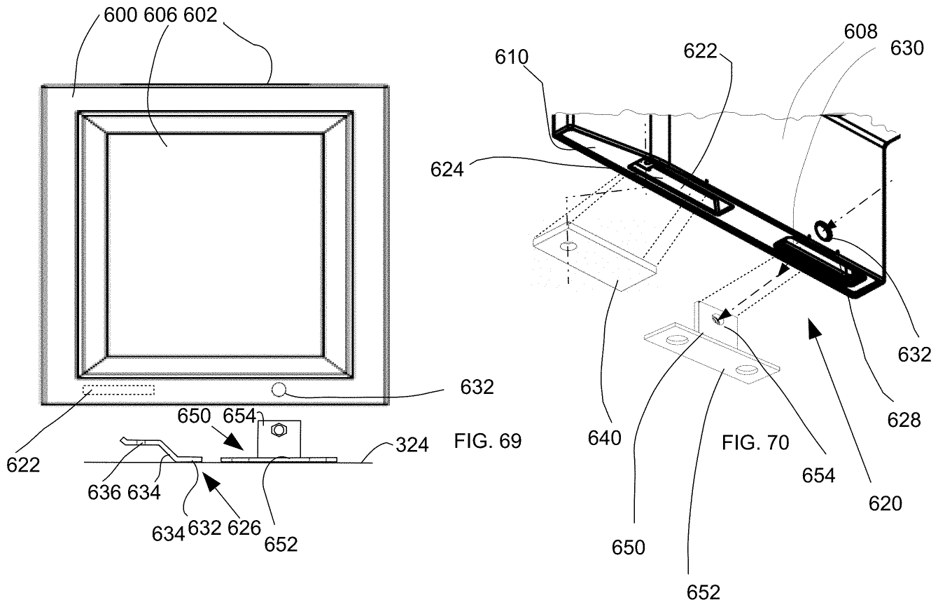

Continuing to refer to FIGS. 69-70, mounting tab 640 is adapted to mount on flange shelf 624 in a generally horizontal orientation. Sliding flange 626 may comprise a z-shaped bracket having a first leg 632 on the floor 324, a second leg 634 angled upward from the floor supporting engagement leg 636 in a generally horizontal orientation. Engagement leg 636 is adapted to extend into flange opening 622 to engage mounting tab 640 wherein mounting tab is between engagement leg 636 and floor 324. Desk bracket 650 may comprise a floor flange 652 and a bolt flange 654. Floor flange 652 is adapted to attach to floor 324 by bolts extending through floor flange 652. Bolt flange 654 comprises a first end 656 on floor flange 652 and s second end 658. Flange hole 660 extends through bolt flange 654 in concentric position with bolt hole 630 when desk 600 is disposed having bolt flange 654 extending into bolt tab pocket 628. Threaded nut 662 is attached to bolt flange opposite bolt hole 630 concentric with flange hole 660. Bolt 661, having tamper resistant head 664 is inserted into bolt hole 630 through flange hole 660 and threadably engages threaded nut 662 to attach desk 600 to floor 324.

Continuing to refer to FIGS. 69-70, mounting tab 640 is attached to shelf 624. Sliding flange 626 is attached to floor 324. Desk bracket 650 is attached to floor 324 by floor flange 652. Desk leg 604 is placed over sliding flange and desk bracket 650 wherein sliding flange 626 is in flange opening 622 and desk bracket 650 is in bolt tab pocket 628. Desk leg 604 is moved in a direction toward desk back 654 urging sliding flange 626 to engage mounting tab 640 wherein engagement leg 636 is disposed between mounting tab 640 and writing surface 602. Bolt hole 630 aligns with flange hole 660. Bolt 661 is inserted through bolt hole 630 to threadably engage nut 662 to secure desk to floor 324.

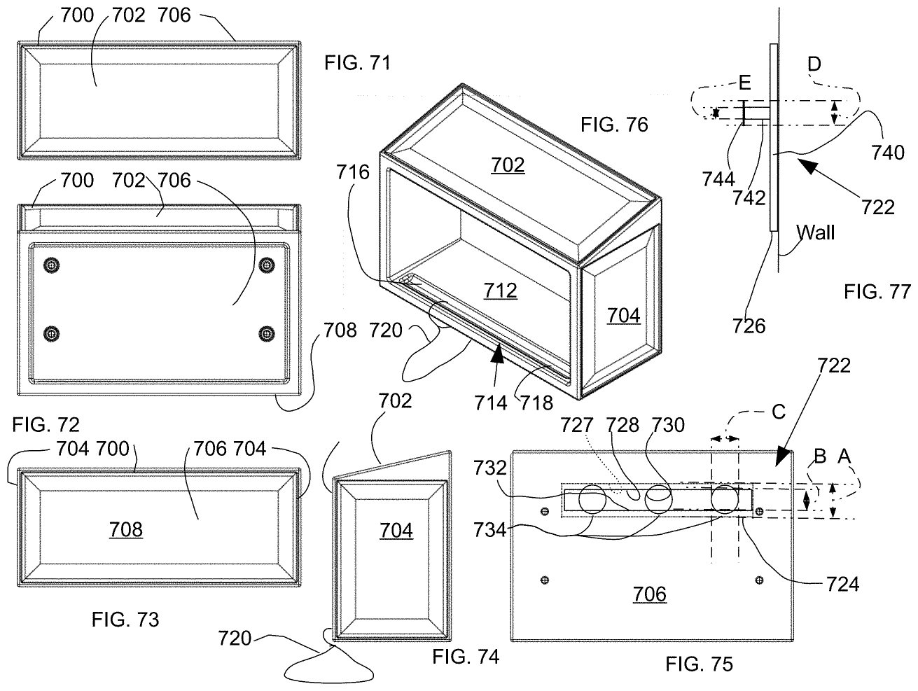

Referring to FIGS. 71-77, the intensive use furniture 10 may comprise a book shelf 700. Book shelf 700 comprising a sloped shelf top 702, a pair of shelf side walls 704 and a shelf back wall 706. Shelf bottom 708 may comprise a storage top 712. Storage top 712 may have a sloping downward orientation from shelf back wall 706. Storage top 712 may further comprise a ligature resistant clothes hanger portion 714 comprising a recessed pocket 716. Recessed pocket 716 may be formed in the storage top 712 as a j-bar configuration having an indented surface portion 718 adapted to receive clothes hanger hooks 720. Recessed pocket 714 is formed in the storage top 712 and does not extend to shelf bottom 708, whereby a ligature resistant clothes hanger portion 714 may be integrally formed in shelf 700. J-bar configuration hangar support comprises a recessed pocket 714 formed in the top surface of bottom shelf adapted to support a clothes hangar hook 720. Shelf 700 may further comprise a French cleat 722 comprising a female cleat portion 724 in shelf back wall 706 and a mating external wall cleat 726. Female cleat portion 724 may be integrally formed in shelf back wall 706 having an internal channel 727 having a first width A in communication with a cleat opening 728. Cleat opening 728 having a second width B. Post openings 730 are formed in communication with internal channel 727. Post openings 730 may be formed along channel 727 at a predetermined insert location 734 along channel 727 spaced from predetermined support locations 732. Second width B is smaller than first width A. Post openings 730 may be round with a diameter C that may be larger than second width B.

Continuing to refer to FIGS. 75 and 77, wall cleat 726 may comprise a wall plate 740, a cleat post 742 and a cleat flange 744. Cleat post 742 may have a first end on wall plate and a second end spaced from wall plate 740. Cleat flange 744 may be disposed on cleat post second end. Cleat flange 744 may further be spaced from and generally parallel to wall plate 740, Cleat flange 744 may have a diameter D that is smaller than diameter C. Cleat post may comprise a width E that is smaller than width B. In use wall plate 740 is mounted on a wall in a predetermined location. Cleat flange 744 is inserted into post opening 730 whereby cleat flange is slidingly trapped in internal channel 727, cleat post may slidingly traverse along cleat opening 728, whereby shelf 700 may be attached to a wall.

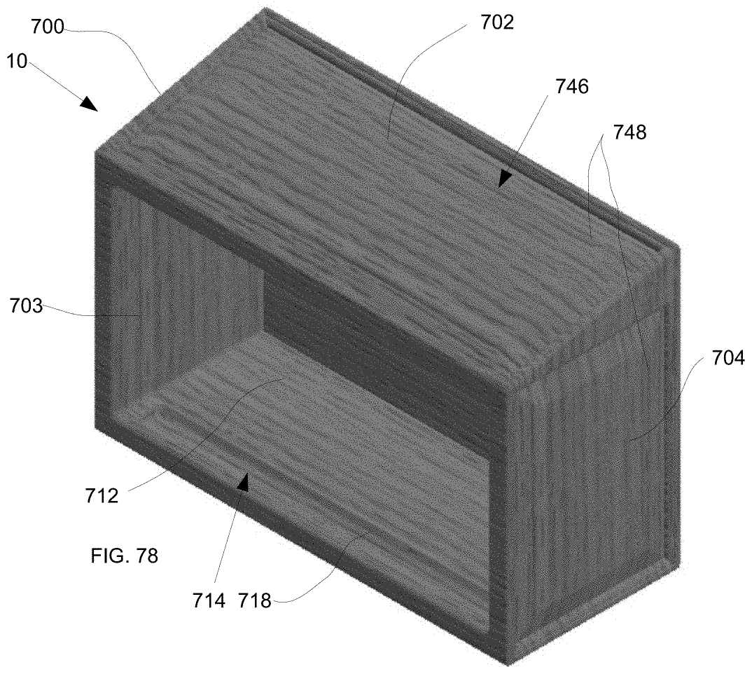

Referring to FIG. 78, the book shelf 700 may comprise a wood-grain finish 746 comprising a directional coloration 748 traversing across shelf top 702 and along shelf side wall 704. An outside soft touch layer 703 may be integrally molded onto the book shelf 700 of a polymer such as poly-ole-a-fin.

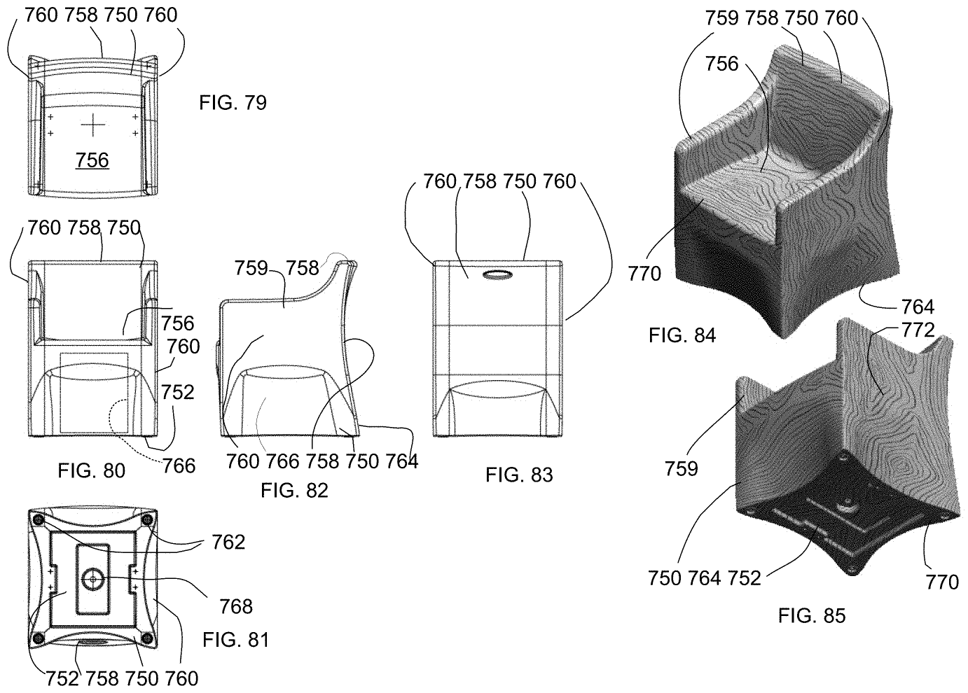

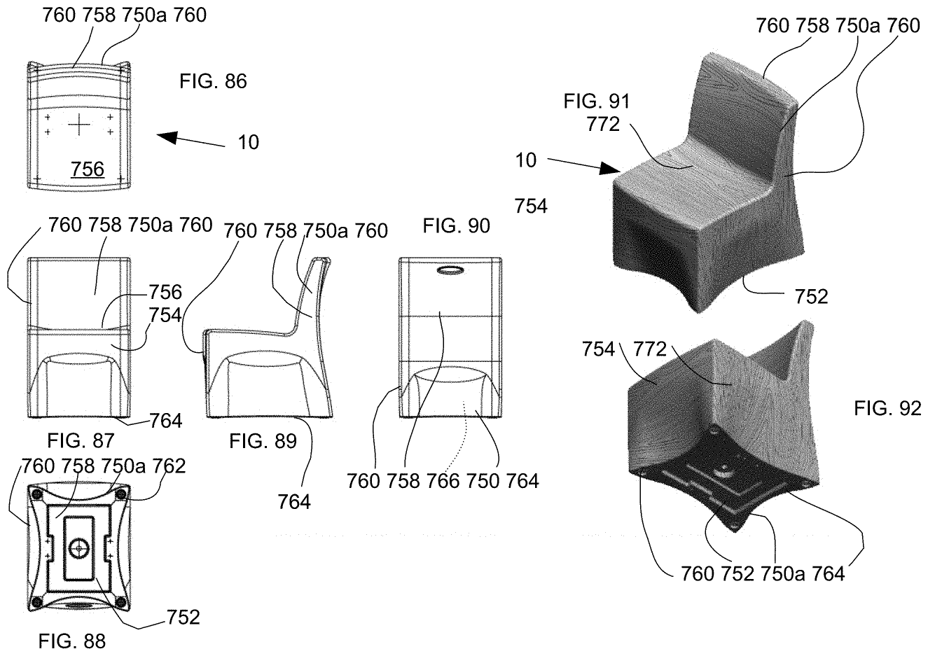

Referring to FIGS. 79-92, skirted chair 750, 750a, may comprise a bottom 752, a front 754, a seat 756, a back 758, arm rests 759 and side walls 760. Skirted chair 750 750a may comprise a plurality of legs 762 within the skirt 764. The skirt 764 extends from the seat 756 to the bottom 752 to reduce ligature tie off on Skirted chair 750, 750a. A ballast chamber 766 may be formed surrounded by seat 756, skirt 764 and bottom 752. Ballast chamber 766 may have sealable ballast opening 768 in bottom 752. Skirted chair 750 may comprise wood grain finish 772 on shell outside 770.

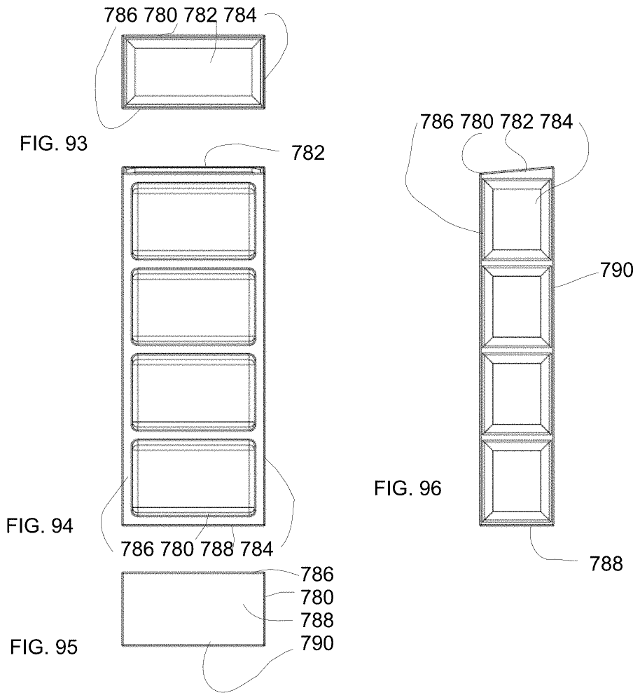

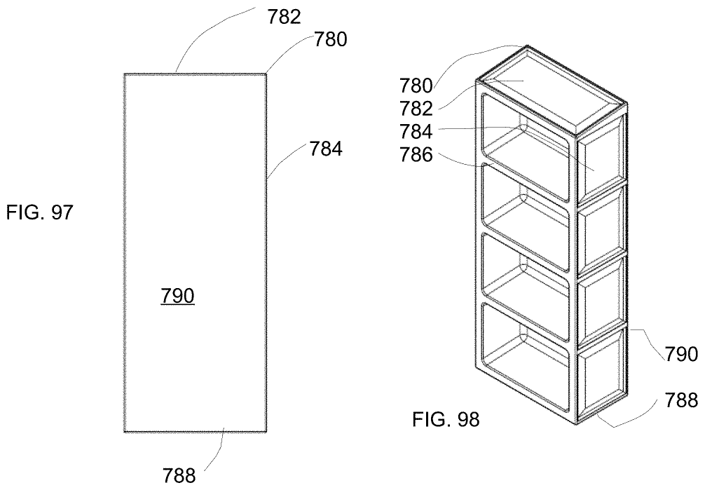

Referring to FIGS. 93-98, a intensive use furniture 10 may be configured as a ligature resistant bookshelf 780 having a sloped bookshelf top 782, a bookshelf side 784, a bookshelf front 786, a bookshelf bottom 788 and a bookshelf back 790.

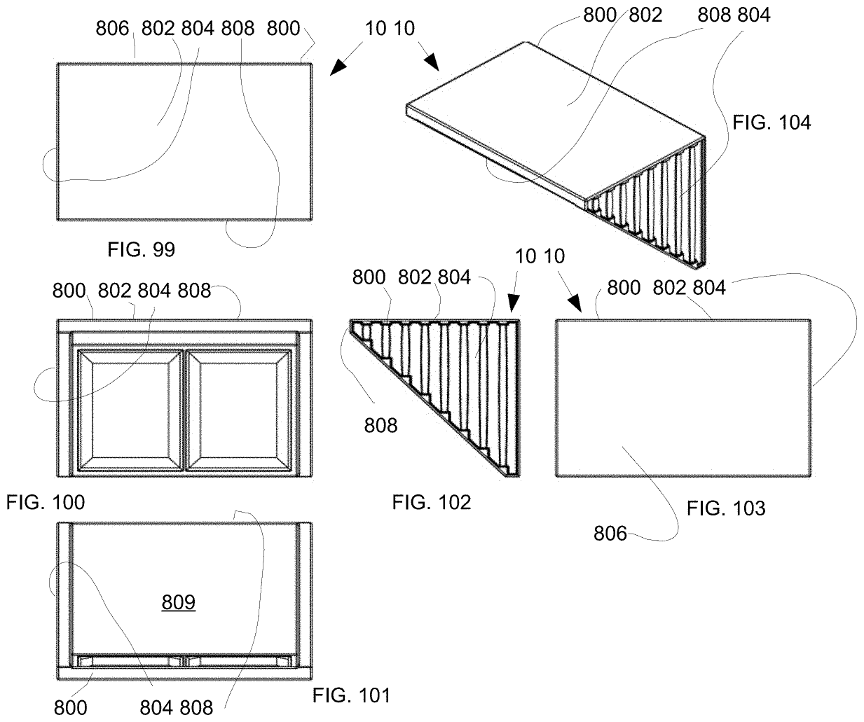

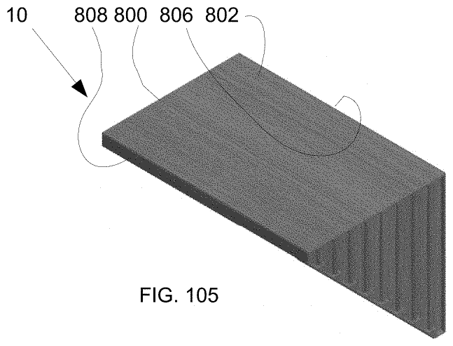

Referring to FIGS. 99-105, intensive use furniture 10 may comprise a wall mounted desk or shelf 800. Wall mounted desk 800 may comprise a writing surface 802 a pair of side panels 804, a desk back 806. Writing surface 802 may comprise a front side 808, a bottom 809 and a back side 810. Desk back 806 is attached to writing surface 802. Desk back 806 extends between the pair of side panels 804.

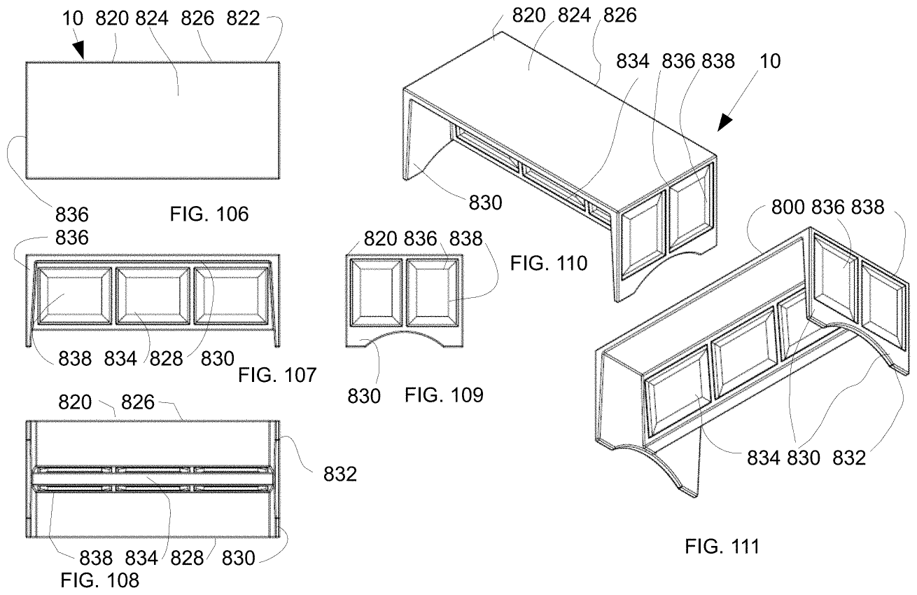

Referring to FIGS. 106-111, intensive use furniture 10 may comprise a coffee table 820. Coffee table 820 may comprise a hollow, one piece body 822 having a coffee table top 824, coffee table back 826, coffee table front 828 and a plurality of coffee table legs 830. Each of the plurality of legs 830 may comprise a tamper resistant glide 832. Coffee table 820 may further comprise a support panel 834 and a pair of end walls 836. Each of the support panel 834 and end walls 836 may comprise raised panels 838.

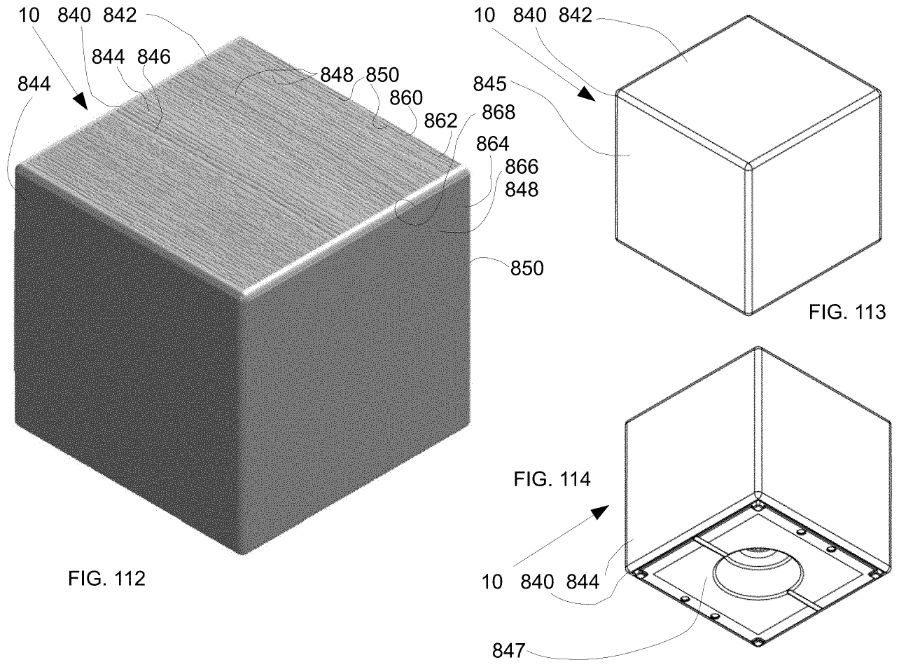

Referring to FIGS. 112-114, intensive use furniture 10 may comprise a multi-color stool 840. Multi-color stool 840 may comprise wood-grain top 842, solid color sides 845 and stool bottom 847. Wood-grain top 842 may comprise light colored plastic streaks of translucent outer layer 844 having first color 880 overlaying base layer having second color 882 appearing as dark colored streaks 846 through translucent outer layer 844. Second color 882 may be darker than first color 860. Light colored streaks 844 may be thin portions of outer layer 848 extending in a generally parallel orientation to each other. Dark streaks 846 may comprise recessed contours 850 in the top surface 842 whereby outer layer 844 is more translucent. Dark streaks 846 may comprise a second color 862. Light colored streaks 844 may comprise a first color 860. Solid color sides 845 may comprise a third color 864 having a top edge 868 integrally molded to top surface 842 and side edges 850 and integrally molded to adjacent color sides 845. Third color 864 may be different from second color 862.

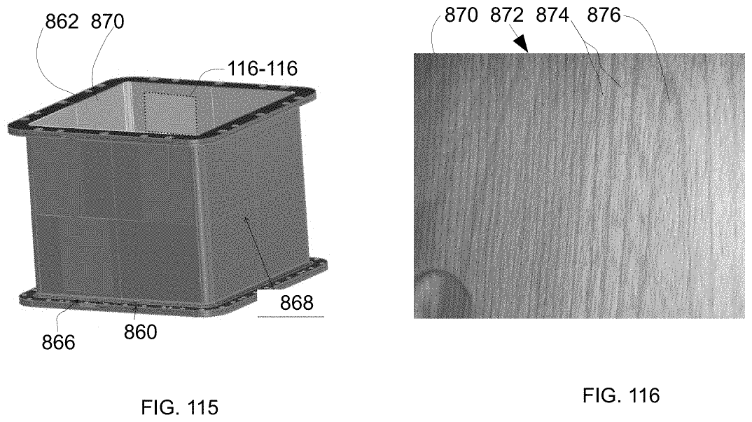

Referring to FIG. 115, furniture 10 may be formed in rotational mold 860 comprising a peek portion 862, first mold flange 864, second mold flange 866, exterior 868 and interior surface 870.

Referring to FIGS. 115-116 etched portion 872 of mold interior surface 870 may comprise mold material removed from the mold interior surface 870 to form recessed grooves 874 carved into the surface. The recessed grooves 974 may comprise varying depths into the mold interior surface 870. The recessed grooves 974 spaced from each other. Each of the plurality of recessed grooves 874 may be disposed in a pattern generally parallel to each other or in oval arcs 876 to simulate a wood surface cut from a tree (Not shown). The recessed grooves 874 may be of various depths from the mold interior surface 870. Translucent outer layer 844 is thicker over recessed grooves 874 giving less translucency.

Continuing to refer to FIGS. 6, 112 and 115-117, First translucent layer 42 may be comprised of plastic compound such as polyethylene applied to mold 860 as a suspension of polyethylene diluted with solvent such as toluene or similar liquid hydrocarbon, as available from Mold In Graphics of Clarkdale, Ariz., such as Color In Systems having a first color 862. First translucent layer 42 is molded to outside base layer 46 having a second color 864 by applying first layer 42 to mold 860 at etched portion 872, drying etched portion 872 by evaporation of solvent, and rotationally molding the intensive use furniture 10 as is known in the prior art by charging the mold with a polymer in a liquid, powder, solid or pellet state by disposing the polymer in the mold and processing with heat, time and rotation of the mold with base layer 46 having second color 864. First color 862 should be complementary to second color 884. First color 862 may be a Panatone number 79 44 29 used with a second color 864 such as RGB 253 210 110. First color 862 may be darker than second color 864

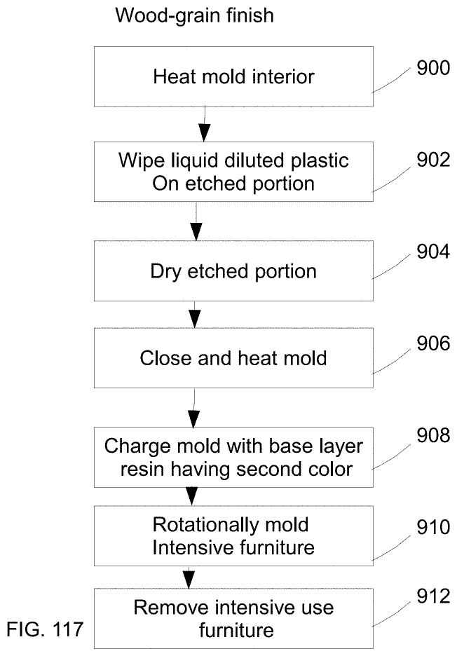

Referring to FIG. 117 translucent layer 42 on shell outside 38 may be disposed on etched portion 872 and molded outside base layer 46 by the steps comprising:

1. Heat 900 the mold interior 870 to a first temperature;

2. Apply 902 first translucent layer 42 as polyethylene diluted with solvent having first color 862 by wiping with towel or sponge, spraying, brushing or other method known for applying liquid having a low viscosity, on to the etched portion 872;

3. Dry 904 etched portion 872 by allowing solvent to evaporate, leaving first first translucent layer 42 disposed in recessed grooves 874;

4. Close and heat 906 mold to operating temperature;

5. Charge 908 heated mold with plastic comprising base layer 46 such as polyethylene having a second color 864;

6. Rotationally mold 910 intensive use furniture 10 by predetermined steps of rotating mold 860 for a predetermined time in a predetermined rotational pattern as is known in the art of rotational molding;

7. Remove 912 intensive use furniture 10 from mold 860.

Second color 864 may be disposed in mold interior surface 870 After allowing diluted polyethylene to evaporate the first color 862 should be complementary to second color 864 the shell outside 38

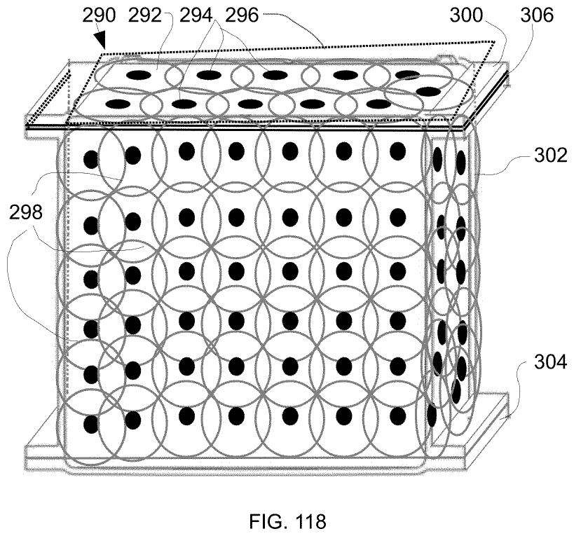

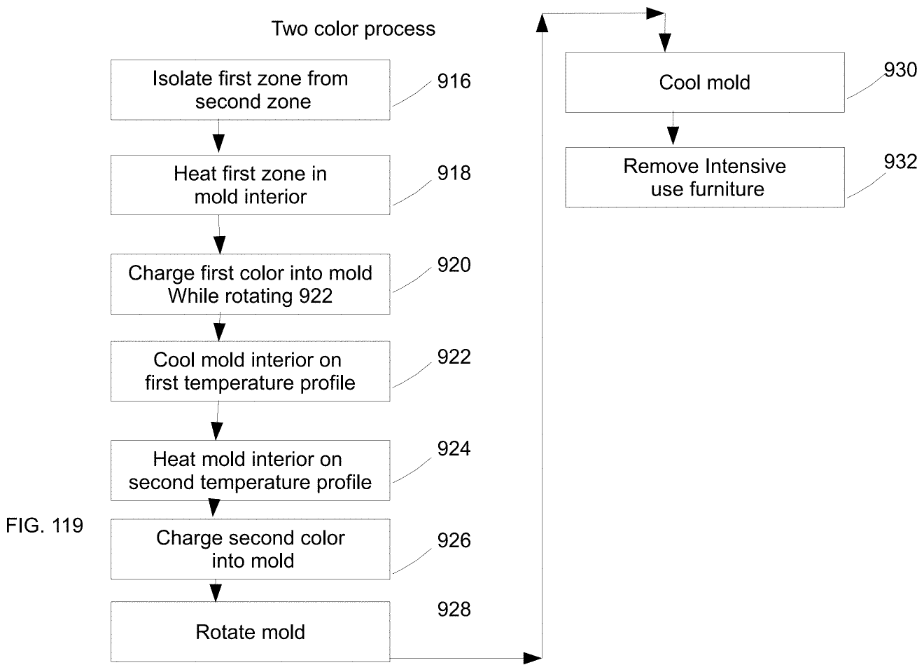

Referring to FIGS. 118-119, two color mold 290 may further comprise a mold shell 292 having local heating elements 294 individually controlled for heating a heat area 298 and grouped into color zones 296. Individual heat areas 298 may overlap with adjacent heat areas 298. Zone 296 may comprise all heating elements 294 on a first mold portion 300. The two color process 914 may comprise the steps of:

1. Isolating 916 the first color zone 296;

2. Energizing 918 the local heating elements 294 in the first color zone 296;

3. Charging 920 first color 862 plastic into two color mold 290;

4. Rotating 922 mold 290 for a predetermined time;

5. Cooling 924 the mold 290 on a first temperature profile;

6. Heating 926 the mold 290 on a second temperature profile adapted to prevent flow over of the first color 862 out of the color zone 296;

7. Charging 928 the mold 290 with a plastic comprising second color 864;

8. Rotating 930 the mold in accordance with standard rotational molding practice at a predetermined speed and for a predetermined time;

9. Cool 932 the mold 290;

10 Remove 934 the intensive use furniture 10.

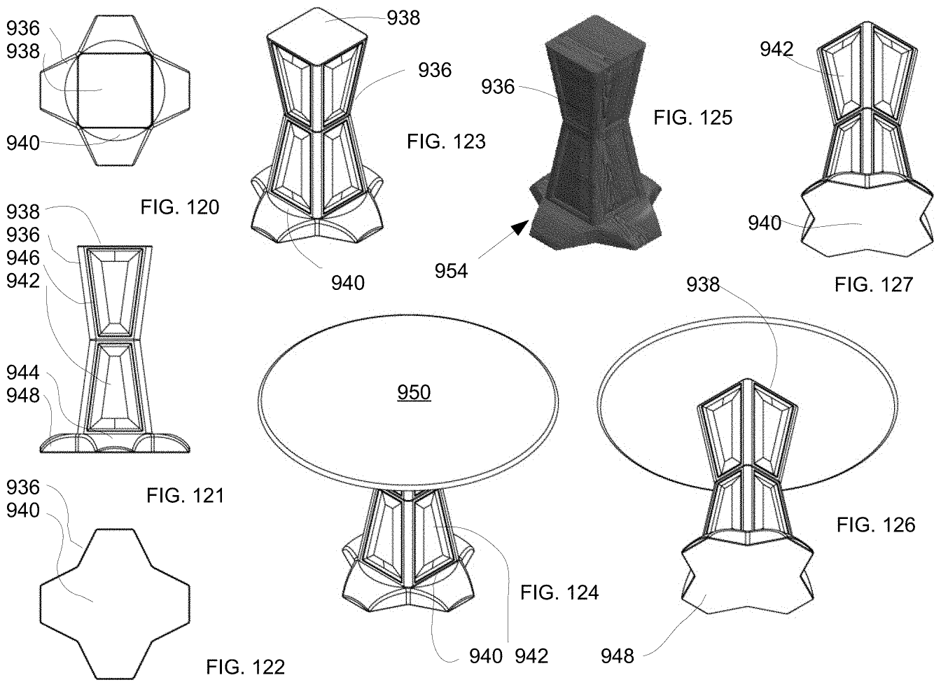

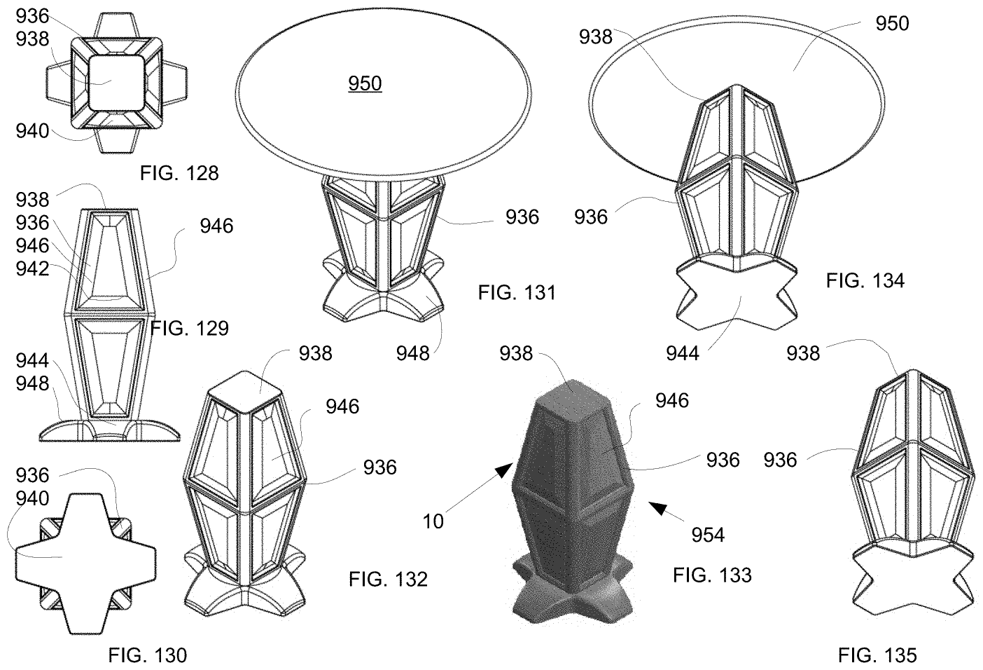

Referring to FIGS. 120-135, intensive use furniture 10 may be configured as a lamp base 936 having a hollow body 946, a lamp base top 938, a base 940 with feet 948. The hollow body 946 may comprise a recessed panel design 942 or a raised panel design 952. The lamp base 936 may further comprise a wood grain effect 954. Table top 950 may be attached at lamp base top 938.

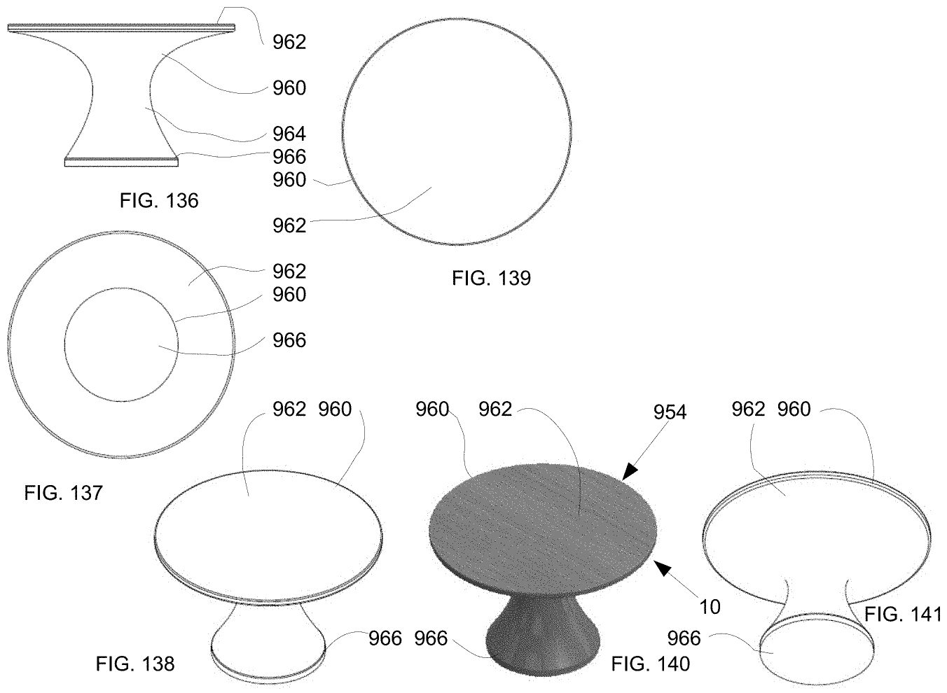

Referring to FIGS. 136-141, intensive use furniture 10 may be configured as a one piece table 960 comprising a table top 962, a pedestal 964 and a base 966. One piece table 960 may further comprise a wood-grain effect 954.

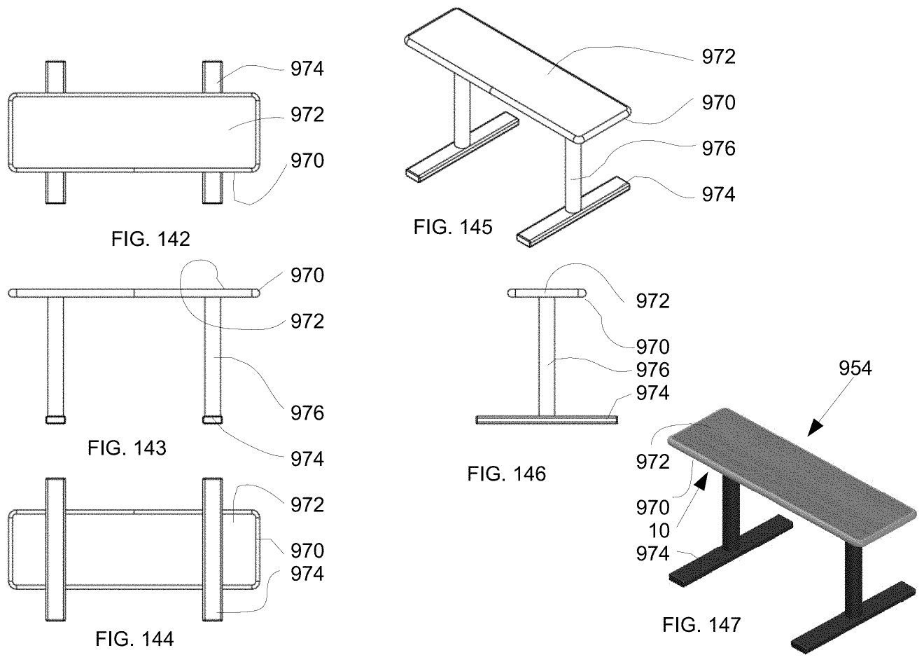

Referring to FIGS. 142-147, intensive use furniture 10 may be configured as an outdoor table 970 comprising a top 972, feet 974 and legs 976. Legs 976 are on feet 974 and extend to outdoor table top 972. Table top 972 may further comprise a wood-grain effect 954.

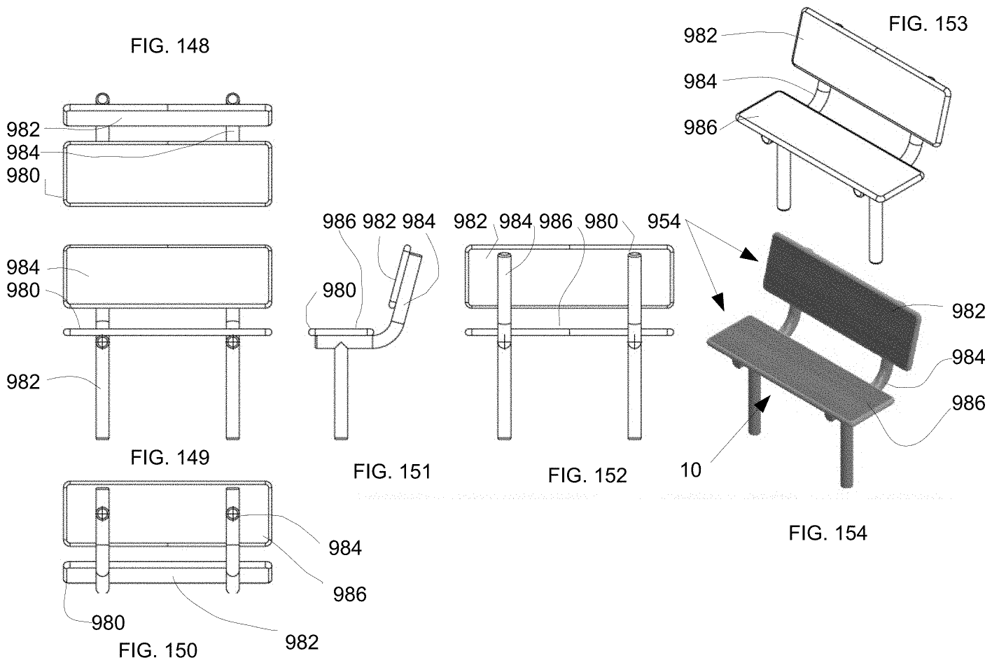

Referring to FIGS. 148-154, intensive use furniture 10 may be configured as a bench with back rest 980 comprising a back 982, frame 984 and seat 986. Back 982 and seat 986 may further comprise a wood-grain effect 954.

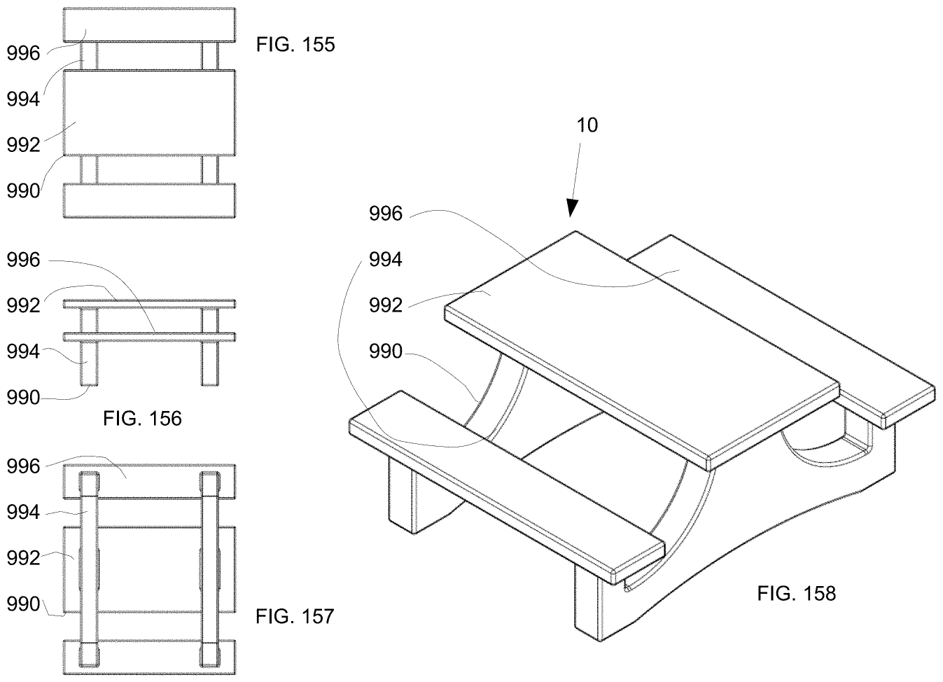

Referring to FIGS. 155-158, intensive use furniture 10 may be configured as a picnic table 990 comprising a table top 992, frame 994 and seat 996. Back 982 and seat 986 may further comprise a wood-grain effect 954.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

1. An intensive use furniture comprising a one piece hollow body comprising an outer shell surrounding a hollow interior, the outer shell comprising a shell inside and a shell outside, the intensive use furniture further comprising:
a first translucent layer, the first translucent layer comprising an first translucent outside, a first translucent inside, plurality of ridges and a plurality of valleys, each one of the plurality of ridges disposed adjacent to one of the plurality of valleys, the first translucent layer comprising a first color;
a second base layer, the second base layer comprising an base outside and a base inside, the base outside on the first translucent inside, the base inside having a base surface area, the base inside surrounding the hollow interior.

2. The intensive use furniture of claim 1, further comprising a plurality of attach ribs, each of the plurality of attach ribs extending from the base inside wherein the plurality of attach ribs increase the base surface area.

3. The intensive use furniture of claim 2, further comprising a foamed third layer, the foamed third layer comprising a base side and a ribbed side, the base side on the base outside, the base side on the plurality of attach ribs, each of the plurality of attach ribs surroundingly attached to the base side, the ribbed side comprising a plurality of support ribs extending into the hollow interior.

4. The intensive use furniture of claim 1, wherein the base layer comprises a second color, the second color different from the first color, the first color darker than the second color.

5. The intensive use furniture of claim 1, wherein the first translucent layer is the same polymeric material as the base layer.

6. The intensive use furniture of claim 1, wherein the first translucent layer is a different polymeric material as the base layer

7. The intensive use furniture of claim 5, wherein the base layer is the same polymeric material as the foamed layer.

8. The intensive use furniture of claim 1, wherein the first translucent layer is the same polymeric material as the foamed layer.

9. A method of making intensive use furniture of claim 1, comprising the steps of:
provide a mold for use in rotational molding, the mold comprising an interior surface, the interior surface comprising an etched portion, the etched portion comprising material removed to form a predetermined design on the interior surface;
provide a liquid polymer;
heat the mold to a first temperature;
apply the liquid polymer on the etched portion;
dry the etched portion;
close the mold;
heat the mold to a second temperature;
provide a base layer polymer resin;
charge the mold with a base layer polymer resin;
mold the base layer with heat and rotation;
open the mold; and
remove the furniture from the mold.

10. The method of making intensive use furniture of claim 9, further comprising the step:
remove excess liquid polymer from the etched portion;
after, apply the liquid polymer on the etched portion; and before, dry the etched portion.

11. The method of making intensive use furniture of claim 9, wherein the step of ‘provide a liquid polymer’ further comprises after—polymer—:
comprising a first color.

12. The method of making intensive use furniture of claim 11, wherein the step of ‘provide a base layer polymer resin’ further comprises after—resin—:
the base layer polymer resin comprising a second color, the first color darker than the second color.

13. The method of making intensive use furniture of claim 9, wherein the step of ‘provide a liquid polymer’ further comprises:
the liquid polymer comprising a polymer compound suspended in a solvent.

14. The method of making intensive use furniture of claim 9, wherein the step of:
provide a sponge;
before ‘apply the liquid polymer on the etched portion’.

15. The method of making intensive use furniture of claim 14, wherein the step of ‘apply the liquid polymer on the etched portion’, further comprises after—etched portion—“using the sponge to wipe the liquid polymer onto the etched portion”.

16. The method of making intensive use furniture of claim 9, further comprising the step of:
cool the mold;
before the step of: ‘heat the mold to a second temperature’.

17. The method of making intensive use furniture of claim 9, further comprising the steps:
provide a foaming polymer;
charge the mold with the foaming polymer;
mold the foamed layer with heat and rotation;
after the step ‘mold the base layer with heat and rotation’ and before the step of ‘ open the mold’.

18. A method of making intensive use furniture having a wood-grain finish comprising the steps of:
provide a mold for use in rotational molding, the mold comprising an interior surface, the interior surface comprising an etched portion, the etched portion comprising material removed to form a predetermined design on the interior surface;
provide a liquid polymer;
heat the mold to a first temperature;
provide a wiper for use with the liquid polymer;
wipe the liquid polymer on the etched portion;
dry the etched portion;
close the mold;
heat the mold to a second temperature;
provide a base layer polymer resin;
dispose the base layer polymer resin in the mold;
rotate the mold for a predetermined time;
provide a foaming polymer;
dispose the foaming polymer in the mold;
rotate the mold for a predetermined time; and
cool the intensive use furniture.
